(19) United States
(12) Patent Application Publication
(10) Pub. No.: US 2008/0210482 A1
(43) Pub. Date: Sep. 4, 2008

(54) Hydraulic Drive Vehicle with Cooling System

(76) Inventors: Norihiro ISHII, Amagasaki-shi (JP); Koji IWAKI, Amagasaki-shi (JP); Fumitoshi ISHINO, Amagasaki-shi (JP); Toshiyuki HASEGAWA, Amagasaki-shi (JP); Hiroaki SHIMIZU, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/021,201

(22) Filed: Jan. 28, 2008

Related U.S. Application Data
(63) Continuation-in-part of application No. 11/433,551, filed on May 15, 2006.

(30) Foreign Application Priority Data
May 18, 2005 (JP) 2005-145694

(51) Int. Cl. A01D 34/63; A01D 69/03; B60K 11/06

(52) U.S. Cl. 180/242; 180/68.2

(57) ABSTRACT

A hydraulic drive vehicle comprises a vehicle frame, a bonnet, a prime mover, a hydraulic transaxle, a seat, a reservoir tank, and a cooling fan and a cooling duct. The bonnet is supported on one of front and rear portions of the vehicle frame, and provided therein with a first space. The prime mover is disposed in the first space. The hydraulic transaxle is driven by the prime mover. The seat is supported on the other of the front and rear portions of the vehicle frame, and is provided therebelow with a second space. The reservoir tank is fluidly connected to the hydraulic transaxle. The cooling fan is driven by the prime mover. The cooling duct is disposed in the second space. The cooling fan and the reservoir tank are disposed in the cooling duct so that the cooling fan cools the reservoir tank. A hydraulic pump for driving the hydraulic transaxle is disposed in the cooling duct so as to be cooled by the cooling fan.

### CROSS REFERENCE TO RELATED APPLICATIONS

This application is a continuation-in-part of U.S. patent application Ser. No. 11/433,551 filed May 15, 2006, which is hereby incorporated in its entirety by reference.

### BACKGROUND OF THE INVENTION

1. Field of the Invention

The invention relates to a cooling system of a hydraulically driven working vehicle, especially, for a large-size vehicle. Especially, the cooling system is provided for cooling a hydraulic pump for driving a hydraulic transaxle or for cooling a reservoir tank fluidly connected to the hydraulic pump or the hydraulic transaxle.

2. Related Art

Conventionally, there is a well-known hydraulically driven working vehicle, equipped with a hydraulic pump disposed in a housing and drivingly connected to a prime mover (internal combustion engine), and with a hydraulic motor disposed outside the housing and fluidly connected to the hydraulic pump so as to drive an axle. U.S. Pat. No. 6,732,828 discloses an example of this type vehicle, wherein a hydraulic pump is disposed in a pump housing, a hydraulic motor for driving an axle is disposed in a transaxle housing separated from the pump housing, and a belt transmission system is interposed between a vertical output shaft of an internal combustion engine and a working device. Further, a reservoir tank is fluidly connected to the pump housing and the transaxle housing so as to supplement fluid for the hydraulic pump in the pump housing and for the hydraulic motor, gears and the like in the transaxle housing.

Since the hydraulic pump is disposed in the pump housing, heat caused by sliding pistons and compressing fluid can be insufficiently radiated from the hydraulic pump, and the heat is accumulated in the pump housing so as to increase the temperature of fluid circulating between the hydraulic pump and motor. Therefore, in the above vehicle, a cooling fan is rotatably integrally provided on a pump shaft projecting outward from the pump housing so as to blow cooling air to the pump housing. However, the cooling air is liable to be expanded and defused, thereby insufficiently cooling the pump housing. Further, to cool fluid in the pump housing and the transaxle housing, the reservoir tank is desired to be effectively cooled. Even if a cooling fan is provided for cooling the reservoir tank, the expansion and decrement of cooling air should also be considered.

### SUMMARY OF THE INVENTION

A first object of the invention is to provide a hydraulic drive vehicle provided with a structure for effectively cooling a reservoir tank fluidly connected to a hydraulic transaxle.

To achieve the first object, a hydraulic drive vehicle according to the invention comprises a vehicle frame, a bonnet, a prime mover, a hydraulic transaxle, a seat, a reservoir tank, a cooling fan and a cooling duct. The bonnet is supported on one of front and rear portions of the vehicle frame, and is provided therein with a first space. The prime mover is disposed in the first space. The hydraulic transaxle is driven by the prime mover. The seat is supported on the other of the front and rear portions of the vehicle frame, and is provided therebelow with a second space. The reservoir tank is fluidly connected to the hydraulic transaxle. The cooling fan is driven by the prime mover. The cooling duct is disposed in the second space. The cooling fan and the reservoir tank are disposed in the cooling duct so that the cooling fan cools the reservoir tank.

Therefore, the cooling duct guides the air blown by the cooling fan to the reservoir tank without expansion and decrement of the air so as to effectively cool the reservoir tank, thereby ensuring the proper performance and durability of the hydraulic transaxle. Further the cooling duct can be provided in the dead space, i.e., the second space below the seat, without interference with other components or without expansion of the vehicle in size.

Preferably, the hydraulic drive vehicle further comprises a hydraulic pump for driving the hydraulic transaxle. The hydraulic pump is disposed in the cooling duct so as to be cooled by the cooling fan.

Therefore, the cooling duct guides the air blown by the cooling fan to the reservoir tank and the hydraulic pump without expansion and decrement of the air so as to effectively cool the reservoir tank and the hydraulic pump, thereby ensuring the proper performance and durability of the hydraulic transaxle and the hydraulic pump.

Preferably, the cooling duct includes an air inlet opened outside of the bonnet.

Therefore, the air outlet can be disposed at an appropriate portion for effectively introducing the outside air into the cooling duct.

A second object of the invention is to provide a hydraulic pump cooling system of a working vehicle for effectively cooling a hydraulic pump for driving a hydraulic transaxle.

To achieve the second object, a hydraulic pump cooling system of a working vehicle according to the invention comprises a prime mover, a hydraulic pump driven by the prime mover, a hydraulic transaxle driven by the hydraulic pump, a working device driven by the prime mover, a cooling fan driven by the prime mover, and a cooling duct in which the cooling fan and the hydraulic pump are disposed so that the cooling fan cools the hydraulic pump.

Therefore, the cooling duct guides the air blown by the cooling fan to the hydraulic pump without expansion and decrement of the air so as to effectively cool the hydraulic pump, thereby ensuring the proper performance and durability of the hydraulic transaxle and the hydraulic pump.

Preferably, the prime mover has a first output shaft extended toward the cooling duct so as to drive the hydraulic pump and the cooing fan.

Therefore, the common first output shaft of the prime mover can be used for driving both the hydraulic pump and the cooling fan so as to reduce the number of components.

Preferably, a drive train for driving the working device is extended from the first output shaft to the outside of the cooling duct.

Therefore, the first output shaft of the prime mover also serves as a primary drive shaft of the drive train for driving the working device so that the drive train for driving the hydraulic pump and the drive train for driving the working device have a concentrated common start portion so as to be compacted.

Alternatively, preferably, the prime mover has a second output shaft opposite to the first output shaft, and a drive train for driving the working device is extended from the second output shaft.

Therefore, a starting portion of the drive train for driving the hydraulic pump and a starting portion of the drive train for driving the working device are distributed opposite to each other with respect to the prime mover, so as to arrange both the drive trains freely from each other

Preferably, the hydraulic pump has a pump shaft coaxially connected to the first output shaft.

Therefore, a gap between the hydraulic pump and the prime mover is shortened and the number of components for driving the hydraulic pump can be reduced, so as to reduce the vehicle in size and cost. Further, the power loss in transmitting power to the hydraulic pump is minimized.

Alternatively, preferably, the hydraulic pump has a pump shaft drivingly connected to the first output shaft through a transmission device.

Therefore, the hydraulic pump having the pump shaft can be located freely from the first output shaft of the prime mover.

Further preferably, the hydraulic pump has a pump shaft drivingly connected to the first output shaft through a gear train.

Therefore, the hydraulic pump having the pump shaft can be located freely from the first output shaft of the prime mover, and can receive power of the prime mover with reduced power loss.

Further preferably, the pump shaft is disposed perpendicular to the first output shaft, and the gear train distributes power of the first output shaft between the pump shaft and the working device.

Therefore, a starting portion of the drive train for driving the hydraulic pump and a starting portion of the drive train for driving the working device are concentrated on the gear train, and the hydraulic pump can be reduced in size in the axial direction of the first output shaft of the prime mover so as to compact the vehicle.

A third object of the invention is to provide an effective reservoir tank cooling system of a hydraulic drive vehicle including a hydraulic transaxle and a reservoir tank fluidly connected to the hydraulic transaxle.

To achieve the third object, a reservoir tank cooling system of a hydraulic drive vehicle according to the invention comprises an internal combustion, a radiator, a radiator fan, a hydraulic transaxle, a reservoir tank and a cooling duct. The radiator fan is drivingly connected to the internal combustion engine. The hydraulic transaxle is driven by the internal combustion engine. The reservoir tank is fluidly connected to the hydraulic transaxle. The radiator fan and the reservoir tank are disposed in the cooling duct so that the radiator fan cools the radiator and the reservoir tank.

Therefore, the cooling duct guides the air blown by the radiator fan to the reservoir tank without expansion and decrement of the air so as to effectively cool the reservoir tank, thereby ensuring the proper performance and durability of the hydraulic transaxle. Further the radiator fan for essentially cooling the radiator is also used for cooling the reservoir tank so as to require no additional cooling fan, thereby reducing the number of components.

Preferably, the reservoir tank cooling system of a hydraulic drive vehicle further comprises a hydraulic pump for driving the hydraulic transaxle. The hydraulic pump is separated from the hydraulic transaxle, and is disposed in the cooling duct so as to be cooled by the radiator fan.

Therefore, the cooling duct guides the air blown by the radiator fan to the reservoir tank and the hydraulic pump without expansion and decrement of the air so as to effectively cool the reservoir tank and the hydraulic pump, thereby ensuring the proper performance and durability of the hydraulic transaxle and the hydraulic pump.

A fourth object of the invention is to provide a lawn tractor provided with a structure for effectively cooling a reservoir tank fluidly connected to a hydraulic transaxle.

To achieve the fourth object, a lawn tractor according to the invention comprises a bonnet, a prime mover, a hydraulic transaxle, a mower, a seat, a reservoir tank, a cooling fan, and a cooling duct. The prime mover is covered with the bonnet. The hydraulic transaxle, the mower and the cooling fan are driven by the prime mover. The reservoir tank is disposed below the seat and is fluidly connected to the hydraulic transaxle. The cooling fan is disposed in the bonnet. The cooling duct is extended from an end portion of the bonnet to a space below the seat so as to guide air blown by the cooling fan to the reservoir tank.

Therefore, in the lawn tractor, the cooling duct guides the air blown by the cooling fan to the reservoir tank without expansion and decrement of the air so as to effectively cool the reservoir tank, thereby ensuring the proper performance and durability of the hydraulic transaxle. Further the cooing fan can be disposed in a dead space in the bonnet, and the cooling duct can be extended from a dead space in the bonnet to a dead space below the seat, without interference with other components or without expansion of the vehicle in size.

A fifth object of the invention is to provide a lawn tractor provided with a structure for effectively cooling fluid used for a hydraulic transaxle.

To achieve the fifth object, a lawn tractor according to the invention comprises a bonnet, a prime mover, a hydraulic pump, a hydraulic transaxle, a mower, a cooling fan, a seat, and a cooling duct. The prime mover is covered with the bonnet. The hydraulic pump, the mower and the cooling fan are driven by the prime mover. The hydraulic transaxle is separated from the hydraulic pump and is driven by the hydraulic pump. The cooling fan is disposed in the bonnet. The seat faces the bonnet and has a space therebelow. The cooling duct guides air blown by the cooling duct into the space below the seat. A sump of fluid used for driving the hydraulic transaxle is disposed in the cooling duct so as to be cooled by the cooling fan.

Therefore, the cooling duct guides the air blown by the cooling fan to the sump of fluid without expansion and decrement of the air so as to effectively cool the fluid for the hydraulic transaxle, thereby ensuring the proper performance and durability of the hydraulic transaxle. Further the cooing fan can be disposed in a dead space in the bonnet, and the cooling duct can be extended from a dead space in the bonnet to a dead space below the seat, without interference with other components or without expansion of the vehicle in size.

In addition, the specification and drawings of the present application disclose an advantageous power transmission system for a working vehicle, among a prime mover, a hydraulic pump, a hydraulic motor for driving an axle and a working device, wherein the hydraulic pump is disposed in a housing and the hydraulic motor is disposed outside the housing so as to be fluidly connected to the hydraulic pump.

The power transmission system of a hydraulically driven working vehicle comprises: a prime mover supported by a vehicle frame, the prime mover including a prime mover output shaft projecting in the fore-and-aft direction of the vehicle; a pump housing; a hydraulic pump disposed in the pump housing; a first hydraulic motor disposed outside the pump housing so as to be fluidly connected to the hydraulic pump; a first transaxle supported by one of front and rear portions of the vehicle frame; a first power take off shaft (a first PTO shaft); and a working power train. The hydraulic pump includes a pump shaft projecting from the pump housing in the fore-and-aft direction of the vehicle so as to be drivingly connected to the prime mover output shaft. The first transaxle includes a first transaxle housing, a pair of first axles disposed in the first transaxle housing so as to be driven by the first hydraulic motor, and a first differential gear unit disposed in the first transaxle housing so as to be drivingly interposed between the first hydraulic motor and the pair of first axles. The working power train extracts a part of power transmitted from the prime mover output shaft to the pump shaft and transmits the extracted power to the first PTO shaft.

The power transmission system is available for various arrangements about the driving connection between the prime mover and the hydraulic pump, the working power train, the first transaxle, etc., without hindering arrangement, attachment and detachment of a working device driven by the first PTO shaft.

With respect to arrangement about the driving connection between the prime mover and the hydraulic pump, preferably, a propeller shaft is drivingly interposed between the prime mover output shaft and the pump shaft, thereby ensuring a flexible driving connection between the prime mover and the hydraulic pump with little power loss.

Alternatively, a belt transmission is drivingly interposed between the prime mover output shaft and the pump shaft, thereby ensuring a simple and flexible driving connection between the prime mover and the hydraulic pump.

Alternatively, the pump shaft is directly connected to the prime mover output shaft, thereby ensuring a minimized driving connection between the prime mover and the hydraulic pump with little power loss.

With respect to arrangement of the working power train, preferably, the working power train includes a gear train, thereby reducing power loss.

Alternatively, the working power train includes a belt transmission, thereby being simple and flexible.

Preferably, the power transmission system further comprises a second power take off shaft (a second PTO shaft) to which the working power train also transmits the extracted power, thereby being available for driving a device in addition to a working device drivingly connected to the first PTO shaft.

Preferably, the power transmission system further comprises a cooling fan disposed on the pump shaft or on a shaft directly connected to the pump shaft, thereby efficiently cooling the pump housing incorporating the hydraulic pump in a small space and with components saved in number.

Preferably, the first hydraulic motor is disposed in the first transaxle housing, thereby minimizing the power transmission system.

Preferably, the first differential gear unit is a bi-directive clutch type differential gear unit. Therefore, the differential drive of the first axles is automatically canceled when either of drive wheels provided on the respective first axles slips, thereby ensuring traction ability and safety of the vehicle in a bad ground condition.

Alternatively, the first differential gear unit includes at least one of a limited slip differential element and a differential lock element. Therefore, differential drive of the first axles is automatically or manually canceled when either of the drive wheels provided on the respective first axles slips, thereby ensuring traction ability and safety of the vehicle in a bad ground condition.

Preferably, the power transmission system further comprises: a second transaxle supported by the other rear or front portion of the vehicle frame. The second transaxle includes a second transaxle housing, a pair of second axles disposed in the second transaxle housing, and a pair of second hydraulic motors disposed in the second transaxle housing so as to be fluidly connected to the hydraulic pump and to drive the respective second axles. Therefore, the vehicle can travel by four-wheel drive so as to increase traction ability.

Alternatively, the power transmission system according to claim 1, further comprises: a second transaxle supported by the other rear or front portion of the vehicle frame. The second transaxle includes a second transaxle housing, a pair of second axles disposed in the second transaxle housing, a second hydraulic motor disposed in the second transaxle housing so as to be fluidly connected to the hydraulic pump, and a second differential gear unit disposed in the second transaxle housing so as to be drivingly interposed between the second hydraulic motor and the pair of second axles. Therefore, the vehicle can travel by four-wheel drive so as to increase traction ability.

Further preferably, the second differential gear unit is a bi-directive clutch type differential gear unit. Therefore, differential drive of the second axles is automatically canceled when either of the drive wheels provided on the respective second axles slips, thereby ensuring traction ability and safety of the vehicle in a bad ground condition.

Alternatively, the second differential gear unit includes at least one of a limited slip differential element and a differential lock element. Therefore, differential drive of the second axles is automatically or manually canceled when either of drive wheels provided on the respective second axles slips, thereby ensuring traction ability and safety of the vehicle in a bad ground condition.

These, further and other objects, features and advantages will appear more fully from the following description with reference to the accompanying drawings.

### BRIEF DESCRIPTION OF THE DRAWINGS

FIG. 1 is a sectional side view of an entire hydraulic four-wheel drive working vehicle equipped with a first power transmission system.

FIG. 2 is a sectional plan view of the entire hydraulic four-wheel drive working vehicle equipped with the first power transmission system.

FIG. 3 is a hydraulic circuit diagram of the hydraulic four-wheel drive working vehicle.

FIG. 4 is a hydraulic circuit diagram of an alternative rear transaxle to be adapted to the hydraulic circuit of FIG. 3.

FIG. 5 is a hydraulic circuit diagram of an alternative front transaxle to be adapted to the hydraulic circuit of FIG. 3.

FIG. 6 is a hydraulic circuit diagram of another alternative front transaxle to be adapted to the hydraulic circuit of FIG. 3.

FIG. 7 is a sectional side view of an entire hydraulic four-wheel drive working vehicle equipped with a second power transmission system.

FIG. 8 is a sectional plan view of the entire hydraulic four-wheel drive working vehicle equipped with the second power transmission system.

FIG. 9 is a sectional side view of a working power train of the vehicle equipped with the second power transmission system.

FIG. 10 is a schematic front view of the working power train of the vehicle equipped with the second power transmission system.

FIG. 11 is a sectional side view of an entire hydraulic four-wheel drive working vehicle equipped with a third power transmission system.

FIG. 12 is a sectional plan view of the entire hydraulic four-wheel drive working vehicle equipped with the third power transmission system.

FIG. 13 is a sectional side view of an entire hydraulic four-wheel drive working vehicle equipped with a fourth power transmission system.

FIG. 14 is a sectional plan view of the entire hydraulic four-wheel drive working vehicle equipped with the fourth power transmission system.

FIG. 15 is a sectional side view of an entire hydraulic four-wheel drive working vehicle equipped with a first cooling system.

FIG. 16 is a sectional side view of an entire hydraulic four-wheel drive working vehicle equipped with a second cooling system.

FIG. 17 is a sectional side view of an entire hydraulic four-wheel drive working vehicle equipped with a third cooling system

FIG. 18 is a sectional side view of an entire hydraulic four-wheel drive working vehicle equipped with a fourth cooling system.

FIG. 19 is a sectional side view of an entire hydraulic four-wheel drive working vehicle equipped with a fifth cooling system.

FIG. 20 is a sectional side view of an entire hydraulic four-wheel drive working vehicle equipped with a sixth cooling system.

FIG. 21 is a sectional side view of an entire hydraulic four-wheel drive working vehicle equipped with a seventh cooling system.

FIG. 22 is a fragmentary sectional side view of the vehicle of FIG. 21, showing a power transmission mechanism from an engine to a hydraulic pump and a working device (a mower).

FIG. 23 is a sectional side view of an entire hydraulic four-wheel drive working vehicle equipped with a eighth cooling system.

FIG. 24 is a fragmentary sectional side view of the vehicle of FIG. 23, showing a power transmission mechanism from an engine to a hydraulic pump and a working device (a mower).

FIG. 25 is a sectional side view of an entire hydraulic four-wheel drive working vehicle equipped with a ninth cooling system.

FIG. 26 is a sectional side view of an entire hydraulic four-wheel drive working vehicle equipped with a tenth cooling system.

FIG. 27 is a sectional side view of an entire hydraulic four-wheel drive working vehicle equipped with a eleventh cooling system.

FIG. 28 is a sectional side view of an entire hydraulic four-wheel drive working vehicle equipped with a twelfth cooling system.

### DETAILED DESCRIPTION OF THE INVENTION

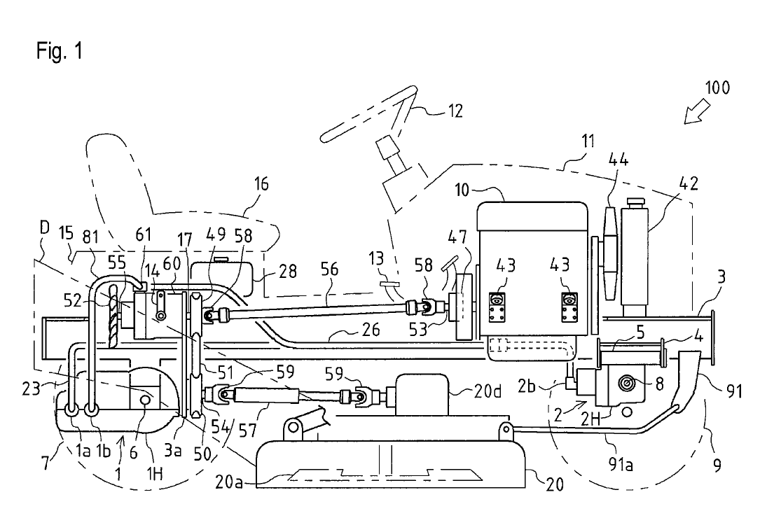

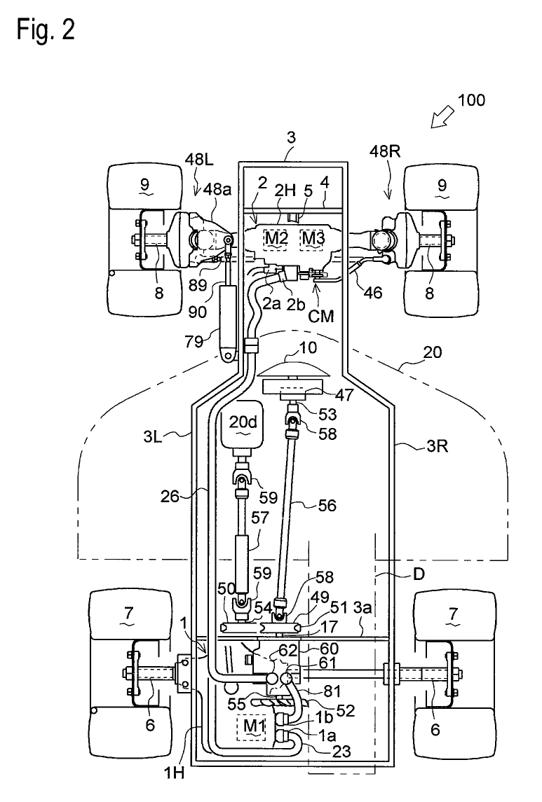

Referring to FIGS. 1 and 2, a hydraulic four-wheel drive working vehicle 100 equipped with a first power transmission system will be described. Vehicle 100 is an Ackerman type steered lawn tractor, comprising: a frame 3; a rear transaxle 1 supported by a rear portion of frame 3; a front transaxle 2 supported by a front portion of frame 3; an internal combustion engine 10, serving as a prime mover, supported by frame 3 between front and rear transaxles 1 and 2; a pump housing 60 supported by frame 3; and a mower 20 (an example of a working device driven by internal combustion engine 10) vertically movably suspended below frame 3. Frame 3 includes a pair of left and right vertical side plate portions 3L and 3R (as shown in FIG. 2) extended substantially in the fore-and-aft direction. Rear transaxle 1 and pump housing 60 are disposed in the inside space of frame 3 between the left and right side plate portions 3L and 3R.

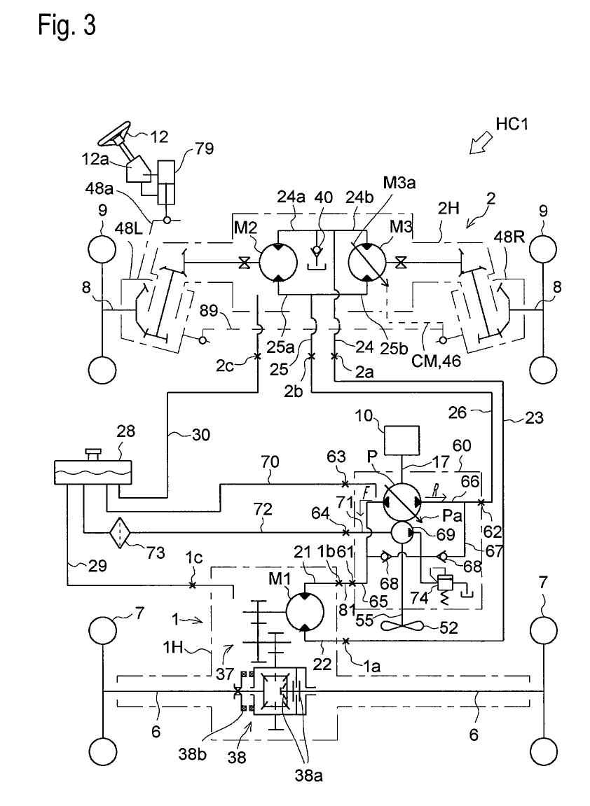

In vehicle 100, pump housing 60 incorporating a variable displacement hydraulic pump P (see FIG. 3) is supported by the rear portion of frame 3 just above rear transaxle 1. In each of later-discussed vehicles 200, 300, 400, 450, 500, 550, 600, 650, 700, 725, 750, 775, 800, 825 and 850, pump housing 60 is disposed at a position different from that of vehicle 100.

Rear transaxle 1 includes a rear transaxle housing 1H incorporating a (fixed displacement) hydraulic motor M1 driven by hydraulic pump P, left and right rear axles 6, a differential gear unit 38 (see FIG. 3) differentially connecting axles 6 to each other, and a deceleration gear train 37 (see FIG. 3) drivingly interposed between hydraulic motor M1 and differential gear unit 38. Alternatively, hydraulic motor M1 may be disposed outside rear transaxle housing 1H and pump housing 60, if hydraulic motor M1 can be fluidly connected to hydraulic pump P. Left and right rear axles 6 project laterally outward from rear transaxle housing 1H so as to be fixedly provided on tips thereof with respective rear wheels 7 serving as unsteerable drive wheels.

Front transaxle 2 includes a front transaxle housing 2H pivoted at a lateral middle top portion thereof onto frame 3 through a center pivot 5 so as to be vertically movable at left and right ends thereof. Front transaxle housing 2H incorporates a pair of left and right hydraulic motors M2 and M3. Left and right front wheel support units 48L and 48R are steerably provided on left and right ends of front transaxle housing 2H, respectively. Axles 8 are supported by respective front wheel support units 48L and 48R, and left and right front wheels 9 are fixed on respective axles 8 so as to serve as steerable drive wheels.

Internal combustion engine 10 is supported by frame 3 through vibro-isolating rubbers 43 and disposed in a bonnet 11. A radiator fan 44 and a radiator 42 are mounted on frame 3 just in front of internal combustion engine 10 in bonnet 11.

A dashboard is formed just behind bonnet 11. A steering wheel 12 is extended upwardly rearward from the dashboard, and operatively connected to a steering control valve disposed in a valve casing 12a (see FIG. 3). The steering control valve is fluidly connected to a power steering cylinder 79 operatively connected to front wheel support units 48L and 48R, so that front wheel support units 48L and 48R, i.e., front wheels 9 are steered by rotating steering wheel 12.

A speed control pedal 13 and a brake pedal (not shown) are disposed at a foot portion of the dashboard. Speed control pedal 13 is a seesaw pedal having oppositely movable front and rear portions with a pivot therebetween. The front portion of pedal 13 is to be depressed for setting forward traveling speed, and the rear portion of pedal 13 is to be depressed for setting backward traveling speed. A speed control lever 14 is pivoted on pump housing 60 so as to interlock with a movable swash plate Pa of hydraulic pump P in pump housing 60, and is operatively connected to speed control pedal 13, so that the rotational direction and speed of rear wheels 7 (and front wheels 9) is controlled by the depression direction and degree of speed control pedal 13.

A rear cover 15 is mounted on a rear portion of frame 3, and a driver's seat 16 is mounted on the top of rear cover 15. A reservoir tank 28 is disposed in rear cover 15 just below seat 16. Reservoir tank 28 is provided at the top thereof with an oiling port which also serves as a breather.

Mower 20 is disposed under frame 3 between rear wheels 7 and front wheels 9. Left and right mower hungers 91 are extended from front end portions of the left and right side plate portions 3L and 3R of frame 3, respectively, and connected to the front end of mower 20 through respective link rods 91a, thereby vertically movably suspending mower 20.

Mower 20 incorporates rotary blades 20a, and is provided at the top thereof with a gearbox 20d for driving rotary blades 20a. A mower input shaft projects rearward from gearbox 20d so as to be drivingly connected to a later-discussed mid PTO shaft 54.

A grass collection device (not shown) can be optionally connected to a rear end portion of vehicle 100 and a grass duct D can be optionally interposed between mower 20 and the grass collection device, so as to collect grass mowed by rotary blades 20a in mower 20. Grass duct D is extended upwardly rearward from a right portion of mower 20 and connected at the rear end thereof to the grass collection device. A duct fan (not shown) is disposed in grass duct D so as to absorb the grass mowed by rotary blades 20a and to blow the grass to the grass collection device through grass duct D. The duct fan is drivingly connected to a later-discussed rear PTO shaft 55.

When grass duct D is attached to vehicle 100, grass duct D is disposed in the inside of frame 3 along the right side plate portion 3R of frame 3. To ensure this rightward eccentric arrangement of grass duct D, as shown in FIG. 2, rear transaxle 1, pump housing 60, reservoir tank 28, a first power transmission system for transmitting power from internal combustion engine 10 to hydraulic pump P and mower 20, hydraulic pressure fluid pipes extended from pump housing 60 and rear transaxle 1, and top gearbox 20d of mower 20 are disposed in the inside of frame 3 leftward from (laterally opposite to) grass duct D.

The first power transmission system between internal combustion engine 10 and hydraulic pump P and mower 20 will be described with reference to FIGS. 1 to 3. As shown in FIGS. 1 and 2, internal combustion engine 10 includes a horizontal output shaft 53 projecting rearward from a flex coupling damper 47 at the rear end of internal combustion engine 10. Output shaft 53 is disposed at the lateral center of frame 3 between the left and right side plate portions 3L and 3R of frame 3.

As shown in FIGS. 1 and 2, vertical and lateral plate-shaped cross member 3a is spanned between the left and right side plate portions 3L and 3R of frame 3. Pump housing 60 is fixed onto a rear surface of cross member 3a so as to be cantilevered rearward from cross member 3a. Hydraulic pump P includes a horizontal pump shaft 17 projecting forward from pump housing 60 through cross member 3a. A pair of fluid suction-and-delivery ports 61 and 62 are disposed on a top surface of pump housing 60.

A propeller shaft 56 is interposed between output shaft 53 of internal combustion engine 10 and pump shaft 17. Propeller shaft 56 is connected at a front end thereof to the rear end of output shaft 53 through a universal joint 58, and at a rear end thereof to the front end of pump shat 17 through another universal joint 58. Referring to FIG. 2, when viewed in plan, pump shaft 17 is slightly offset leftward from output shaft 53 so as to be prevented from interfering with grass duct D, so that propeller shaft 56 is slightly inclined rearwardly leftward. Further, referring to FIG. 1, when viewed in side, pump shaft 17 is disposed slightly lower than output shaft 53, so that propeller shaft 56 is slightly inclined rearwardly downward.

As shown in FIGS. 1 and 2, rear transaxle housing 1H is disposed leftwardly downward from pump housing 60 and fixed to the left side plate portion 3L of frame 3. A pair of fluid suction-and-delivery ports 1a and 1b are disposed on a right side surface of rear transaxle housing 1. A pipe 81 is interposed between port 61 on pump housing 60 and port 1b on rear transaxle housing 1H.

Differential gear unit 38 is provided with a limited slip differential (LSD) element 38a and a differential lock element 38b. Differential lock element 38b is manually operated so as to lock axles 6 to each other, i.e., cancel the differential rotation of axles 6, thereby transmitting torque to rear wheel 7 slipping in mud or a ditch. However, even when differential lock element 38b is not operated for differential lock, LSD element 38a transmits a considerable amount of power to the slipping wheel 7. LSD element 38a can be any type element, such as an element including a pair of helical planetary gears, or a viscous coupling type element. Differential gear unit 38 may be provided with either LSD element 38a or differential lock element 38b. Alternatively, differential gear unit 38 may be a normal differential gear unit with neither LSD element 38a nor differential lock element 38b.

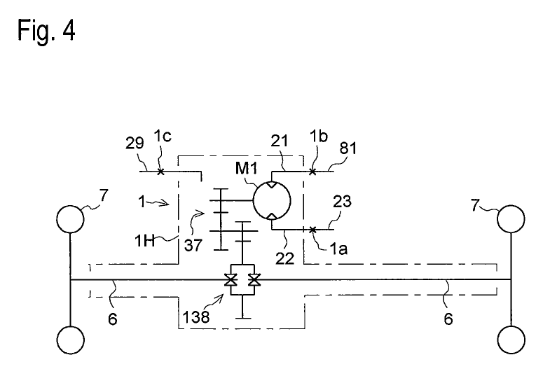

Alternatively, the differential gear unit disposed in rear transaxle housing 1H may be a bi-directive clutch type differential gear unit 138, as shown in FIG. 4, which can automatically transmit power to rear wheel 7 slipping in mud or a ditch.

Referring to front transaxle 2, hydraulic motor M2 is fixed in displacement, and hydraulic motor M3 is variable in displacement. Alternatively, both the hydraulic motors for driving respective axles 8 may be variable in displacement.

Variable displacement hydraulic motor M3 is provided with a movable swash plate M3a (see FIG. 3). A cam mechanism CM interlocking with swash plate M3a is disposed along the rear surface of front transaxle housing 2H. In this embodiment, the right hydraulic motor for right axle 8 is variable displacement hydraulic motor M3. Therefore, cam mechanism CM is disposed rearwardly leftward of front transaxle housing 2H availably for connection to swash plate M3a.

Referring to FIG. 2, left and right front wheel support units 48L and 48R are connected to each other through a tie rod 89. Cam mechanism CM is connected to one of front wheel support units 48L and 48R (in this embodiment, right front wheel support unit 48R) through a link 46, so as to transmit left or right turning of front wheel support units 48L and 48R to movable swash plate M3a. Therefore, when steerable front wheels 9 are steered by rotating steering wheel 12, the tilt angle of movable swash plate M3a is reduced so as to accelerate axles 8 (front wheels 9), thereby ensuring smooth turning of vehicle 100 without dragging of wheels 9.

Referring to FIG. 2, power steering cylinder 79 is disposed along the outside surface of a front portion of the left side plate portion 3L of frame 3. A bracket 48a is fixed on left front wheel support unit 48L (opposite to right front wheel support unit 48R connected to cam mechanism CM), and a piston rod 90 of power steering cylinder 79 is pivoted at the front tip thereof onto bracket 48a. The telescopic movement of piston rod 90 of power steering cylinder 79 is controlled by the steering control valve in valve casing 12a based on the rotation direction and angle of steering wheel 12 so as to turn left front wheel support unit 48L, thereby also turning right front wheel support unit 48R through tie rod 89.

A pair of fluid suction-and-delivery ports 2a and 2b are disposed on the rear left surface of front transaxle housing 2H laterally opposite to cam mechanism CM. A pipe 23 is interposed between port 2a and port 1a on rear transaxle housing 1H, and a pipe 26 is interposed between port 2b and port 62 on pump housing 60. Pipes 23 and 26 are extended along the left side plate portion 3L of frame 3. In this way, pump housing 60, rear transaxle housing 1H and front transaxle housing 2H are mutually fluidly connected through pipes 81, 23 and 26.

A working power train for driving an attached working device such as mower 20 will be described. As shown in FIGS. 1 and 2, a pulley 49 is fixed on a portion of pump shaft 17 projecting forward from cross member 3a. A pulley 50 is supported onto the front surface of cross member 3a downwardly leftward from pulley 49. A belt 51 is interposed between pulleys 49 and 50. A tension clutch (not shown) is interposed between pulleys 49 and 50, so as to selectively tighten belt 51 to transmit torque of pulley 49 to pulley 50 or loosen belt 51 to isolate pulley 50 from torque of pulley 49. Pulley 50 has a forwardly projecting horizontal pulley shaft serving as mid PTO shaft 54. Gearbox 20d on mower 20 is disposed in front of mid PTO shaft 54, and a propeller shaft 57 is interposed between mid PTO shaft 54 and the input shaft projecting rearward from gearbox 20d through respective universal joints 59.

Pump shaft 17 is extended rearward so as to have a portion projecting rearward from pump housing 60, serving as a rear PTO shaft 55. A clutch box can be connected to rear PTO shaft 55, and the above-mentioned duct fan in grass duct D can be drivingly connected to rear PTO shaft 55.

In this way, a part of power transmitted from internal combustion engine 10 to pump shaft 17 for driving hydraulic pump P is extracted to transmitted to mid PTO shaft 54 and rear PTO shaft 55, so as to drive working devices drivingly connected to respective PTO shafts 54 and 55.

In the embodiment shown in FIGS. 1 and 2, a cooling fan 52 is fixed on rear PTO shaft 55 (the rearwardly extended portion of pump shaft 17) so as to blow air forward onto pump housing 60. The cooling air from cooling fan 52 is reflected by cross member 3a so as to also cool rear transaxle housing 1H. In this way, the number of components for cooling pump housing 60 and rear transaxle housing 1H is saved by providing cooling fan 52 on the extended portion of pump shaft 17 serving as rear PTO shaft 55.

Referring to FIG. 3, an HST circuit HC1 of vehicle 100 will be described. As mentioned above, pipe 81 is interposed between port 61 of pump housing 60 and port 1b of rear transaxle housing 1H, pipe 23 is interposed between port 1a of rear transaxle housing 1H and port 2a of front transaxle housing 2H, and pipe 26 is interposed between port 2b of front transaxle housing 2H and port 62 of pump housing 60.

In pump housing 60, a passage 65 is interposed between hydraulic pump P and port 61, and a passage 66 is interposed between hydraulic pump P and port 62. It is defined that, during forward travel of vehicle 100, the delivery port of hydraulic pump P is connected to passage 65 and port 61, and the suction port of hydraulic pump P to passage 66 and port 62.

In rear transaxle housing 1H, a passage 22 is interposed between hydraulic motor M1 and port 1a, and a passage 21 is interposed between hydraulic motor M1 and port 1b.

In front transaxle housing 2H, a passage 24 is extended from port 2a and bifurcated into passages 24a and 24b connected to respective hydraulic motors M2 and M3, and a passage 25 is extended from port 2b and bifurcated into passages 25a and 25b connected to respective hydraulic motors M2 and M3.

In this way, HST circuit HC1 is configured so that hydraulic motor M1 for driving rear axles 6 and the pair of hydraulic motors M2 and M3 for driving front axles 8 are fluidly connected in series to hydraulic pump P, and hydraulic motors M2 and M3 are fluidly connected in parallel to hydraulic pump P so as to differentially drive front axles 8.

When vehicle 100 travels forward (speed control pedal 13 is depressed for forward traveling), fluid delivered from hydraulic pump P is supplied to hydraulic motor M1 through passage 65, port 61, pipe 81, port 1b and passage 21, subsequently supplied to hydraulic motors M2 and M3 through passage 22, port 1a, pipe 23, port 2a and passage 24 (passages 24a and 24b), and returned to hydraulic pump P through passage 25 (passages 25a and 25b), port 2b, pipe 26, port 62 and passage 66. In other words, during forward travel of vehicle 100, ports 61, 1a and 2b serve as delivery ports, and ports 62, 1b and 2a serve as suction ports. When vehicle 100 travels backward, the fluid supply route is reversed, so that ports 61, 1a and 2b serve as suction ports, and ports 62, 1b and 2a serve as delivery ports.

An unshown drive mode switching valve may be disposed across pipes 23 and 26. The valve is shiftable between a two-wheel drive position and a four-wheel drive position. When the valve is disposed at the four-wheel drive position, the valve thoroughly opens pipe 23 between ports 1a and 2a, and pipe 26 between ports 2b and 62, thereby supplying hydraulic motors M2 and M3 with fluid delivered from hydraulic pump P. When the valve is disposed at the two-wheel drive position, the valve bypasses between ports 1a and 62 so as to circulate fluid between hydraulic pump P and hydraulic motor M1 without supplying hydraulic motors M2 and M3 with fluid from hydraulic pump P. Simultaneously, the valve disposed at the two-wheel drive position bypasses between ports 2a and 2b so as to allow the free rotation of hydraulic motors M2 and M3 isolated from hydraulic pressure supplied by hydraulic pump P.

Pump housing 60, rear transaxle housing 1H and front transaxle housing 2H are filled therein with fluid so as to serve as respective fluid sumps. Pump housing 60 is provided with a drain port 63, rear transaxle housing 1H is provided with a drain port 1c, and front transaxle housing 2H is provided with a drain port 2c. Reservoir tank 28 is connected to drain port 63 through a pipe 70, to drain port 1c through a pipe 29, and to drain port 2c through a pipe 30, so as to absorb excessive fluid from any of pump housing 60, rear transaxle housing 1H and front transaxle housing 2H, when the corresponding fluid sump is excessively expanded.

Pump housing 60 incorporates a charge pump 69, which is driven together with hydraulic pump P by pump shaft 17. In this regard, pump shaft 17 penetrates hydraulic pump P and charge pump 69 so as to project forward to serve as the input shaft drivingly connected to internal combustion engine 10, and to project rearward to serve as rear PTO shaft 55. A suction port 64 is opened on pump housing 60, and connected to reservoir tank 28 through a pipe 72 outside pump housing 60, and to charge pump 69 through a passage 71 in pump housing 60. A filter 73 is provided on an intermediate portion of pipe 72.

In pump housing 60, a charge fluid passage 67 is extended from charge pump 69 and connected to passages 65 and 66 through respective check valves 68, so as to supply fluid delivered from charge pump 69 to lower-pressurized one of passages 65 and 66. A pressure-regulating valve 74 is connected to passage 67 at the upstream side of check valves 68 so as to drain excessive fluid to the fluid sump in pump housing 60.

Incidentally, a hydraulic fluid source of the steering control valve in valve casing 12a is omitted in FIG. 3. Preferably, instead of charge fluid passage 67 connected to passages 65 and 66, the fluid delivered from charge pump 69 may be extracted from pump housing 60 to be supplied to the steering control valve, and subsequently, the fluid may be introduced into pump housing 60 so as to be supplied to either of passages 65 and 66.

In front transaxle housing 2H, a check valve 40 is connected to passage 24a so as to supply fluid from the fluid sump in front transaxle housing 2H to passage 24a at the upstream side of hydraulic motor M2 during forward travel of vehicle 100, thereby preventing cavitation caused by dragging of front wheels 9 by rear wheels 7.

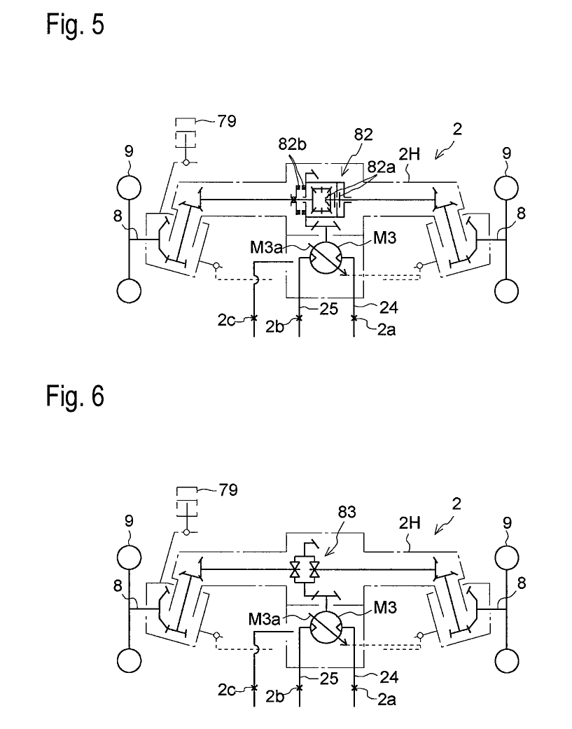

The parallel connected hydraulic motors M2 and M3 may be replaced with combination of variable displacement hydraulic motor M3 and a differential gear unit 82, as shown in FIG. 5. Differential gear unit 82 is driven by hydraulic motor M3 and differentially connects axles 8 to each other. In front transaxle housing 2H shown in FIG. 5, differential gear unit 82 is provided with a limited slip differential (LSD) element 82a and a differential lock element 82b. Differential lock element 82b is manually operated so as to lock axles 8 to each other, i.e., cancel the differential rotation of axles 8, thereby transmitting torque to front wheel 9 slipping in mud or a ditch. However, even when differential lock element 82b is not operated for differential lock, LSD element 82a transmits a considerable amount of power to the slipping wheel 9. LSD element 82a can be any type element, such as an element including a pair of helical planetary gears, or a viscous coupling type element. Differential gear unit 82 may be provided with either LSD element 82a or differential lock element 82b. Alternatively, differential gear unit 82 may be a normal differential gear unit with neither LSD element 82a nor differential lock element 82b.

Differential gear unit 82 shown in FIG. 5 may be replaced with a bi-directive clutch type differential gear unit 83 as shown in FIG. 6, which is clutched off for establishing the two-wheel drive mode during normal travel of vehicle 100, and is automatically clutched on for establishing the four-wheel drive mode when the travel condition of vehicle 100 becomes abnormal.

Alternatively, in vehicle 100, transaxle 2 supporting steerable wheels 9 may serve as a rear transaxle supporting steerable rear wheels, transaxle 1 supporting unsteerable wheels 7 may serve as a front transaxle supporting unsteerable front wheels, and internal combustion engine 10 may be disposed between transaxles 1 and 2 so as to have output shaft 53 projecting forward to be drivingly connected to hydraulic pump P in pump housing 60 disposed in front of internal combustion engine 10.

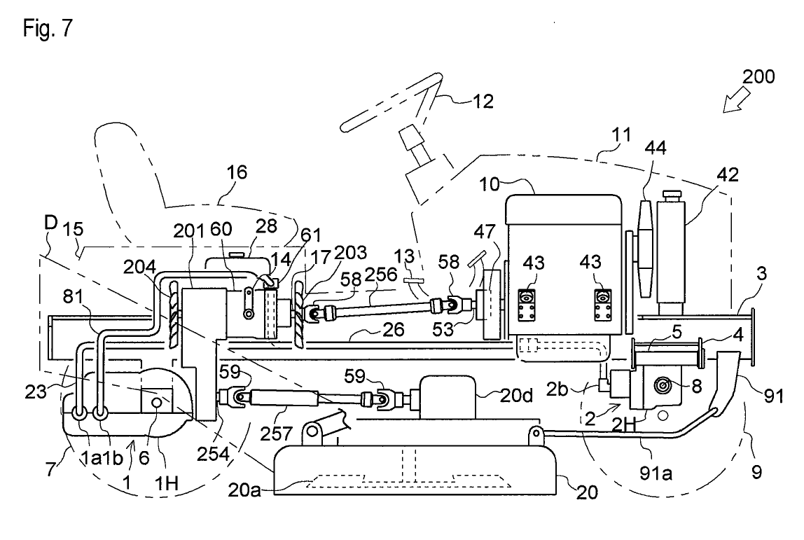

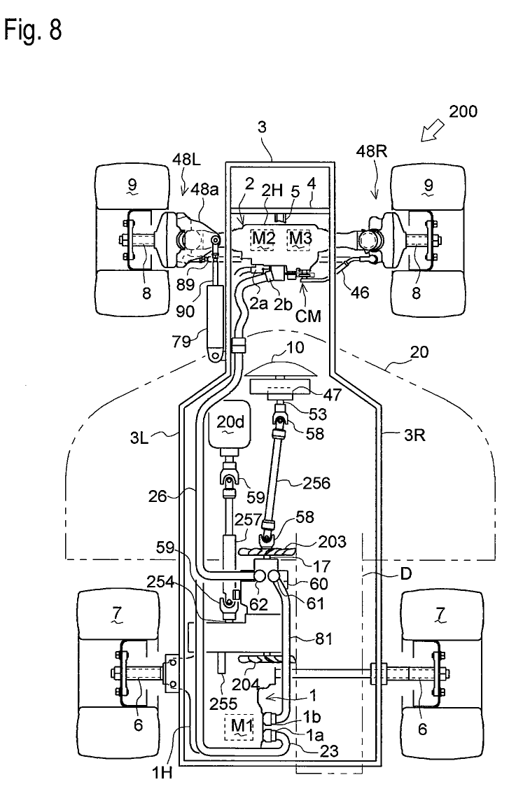

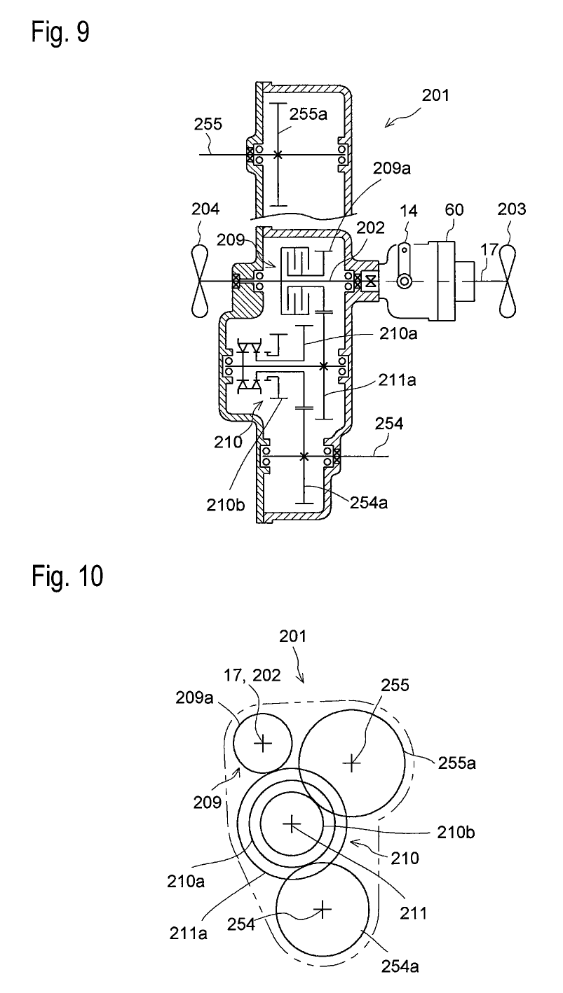

Alternative vehicle 200 equipped with a second power transmission system will be described with reference to FIGS. 7 to 10. Parts and components having the same function as those of vehicle 100 are designated by the same reference numerals. With respect to the second power transmission system for transmitting power of internal combustion engine 10 to hydraulic pump P and mower 20, a PTO gearbox 201 is fixed onto the left side plate portion 3L of frame 3, and pump housing 60 is fixed onto a front surface of PTO gearbox 201 so as to transmit power to a gear train in PTO gearbox 201. Pump shaft 17 projects forward from pump housing 60. A propeller shaft 256 is interposed between output shaft 53 of internal combustion engine 10 and pump shaft 17 through respective universal joints 58. Pump shaft 17 projects rearward from pump housing 60 into PTO gearbox 201 so as to serve as an input shaft 202 of the gear train in PTO gearbox 201.

A counter shaft 211, a mid PTO shaft 254 and a rear PTO shaft 255 are rotatably disposed in PTO gearbox 201 in the fore-and-aft direction (in parallel to input shaft 202). Mid PTO shaft 254 is disposed downwardly leftward (in FIG. 10, downwardly rightward) from input shaft 202 and projects forward from PTO gearbox 201. Rear PTO shaft 255 is disposed leftward (in FIG. 10, rightward) from input shaft 202 and projects rearward from PTO gearbox 201.

In PTO gearbox 201, clutches 209 and 210 are drivingly interposed in series between input shaft 202 and PTO shafts 254 and 255. Clutch 209 is selectively clutched on for transmitting power from input shaft 202 to clutch 210, or clutched off for isolating power of input shaft 202 from clutch 210. Clutch 210 is selectively clutched on for transmitting power of counter shaft 110 to rear PTO shaft 255, or clutched off for isolating power of counter shaft 110 from rear PTO shaft 255.

More specifically, in PTO gearbox 201, a gear 211a is fixed on counter shaft 211, and gears 254a and 255a are fixed on respective PTO shafts 254 and 255. A gear 209a is relatively rotatably provided on input shaft 202 and constantly meshes with gear 211a. Clutch 209 is interposed between gear 209a and input shaft 202. Clutch 209 is selectively clutched on for not-relatively rotatably engaging gear 209a to input shaft 202 to thereby drive counter shaft 211, or clutched off for disengage gear 209a from input shaft 202 to thereby shut off rotation of input shaft 202 from counter shaft 211.

A gear 210a is not relatively rotatably provided on counter shaft 211 and constantly meshes with gear 254a. That is, mid PTO shaft 254 is driven by input shaft 202 unless clutch 209 is clutched off and regardless of whether clutch 210 is clutched on or off. A gear 210b is relatively rotatably provided on a boss portion of gear 210a and constantly meshes with gear 255a. Clutch 210 is interposed between counter shaft 211 and gear 210b. Clutch 210 is selectively clutched on for not-relatively rotatably engaging gear 210b to counter shaft 211 to thereby drive rear PTO shaft 255, or clutched off for disengage gear 210b from counter shaft 211 to thereby shut off rotation of counter shaft 211 from rear PTO shaft 255.

A propeller shaft 257 is interposed between mid PTO shaft 254 and the input shaft projecting rearward from gearbox 20d on mower 20 through respective universal joints 59 so as to transmit power of mid PTO shaft 254 to rotary blades 20a.

When grass duct D with the duct fan is attached onto vehicle 200, the duct fan is drivingly connected to rear PTO shaft 255. Due to clutch 210 in PTO gearbox 201, another clutch does not have to be interposed between rear PTO shaft 255 and a device for driving the duct fan.

A cooling fan 203 is fixed on the forward projecting portion of pump shaft 17 in front of pump housing 60. Cooling fan 203 blows air rearward to pump housing 60 and the front surface of PTO gearbox 201, so as to cool hydraulic pump P in pump housing 60 and the gears and clutches in PTO gearbox 201. Cooling fan 203 also blows air to pipes 26 and 81 disposed adjacent to cooling fan 203, thereby efficiently cooling fluid circulating in HST circuit HC1.

Further, input shaft 202 (the rearward extended portion of pump shaft 17) projects rearward from PTO gearbox 201 so as to be fixedly provided thereon with a cooling fan 204. Cooling fan 204 blows air forward to the rear surface of PTO gearbox 201, so as to effect cooling of PTO gearbox 201 with the assistance of cooling fan 203. The rear surface of PTO gearbox 201 reflects the air blown from cooling fan 204 rearward toward rear transaxle housing 1H, thereby cooling components in rear transaxle housing 1H. Alternatively, cooling fan 204 may blow air rearward toward rear transaxle housing 1H.

Pump housing 60, PTO gearbox 201, rear transaxle housing 1H, mower gearbox 20d, reservoir tank 28 and pipes 23, 26 and 81 are laterally eccentrically collected (leftward) so as to ensure optional arrangement of grass duct D in a (rightward) space laterally opposite to these power transmission components.

The above-mentioned alternative arrangements adaptable to vehicle 100, such as bi-directive clutch type differential gear unit 135 in rear transaxle 1 and the combination of hydraulic motor M3 and differential gear unit 82 or 83 in front transaxle 2, are also adaptable to vehicle 200.

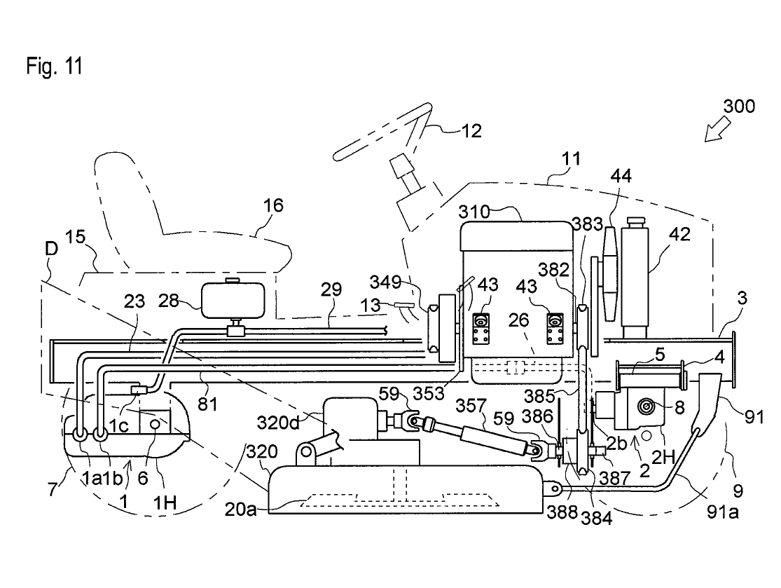

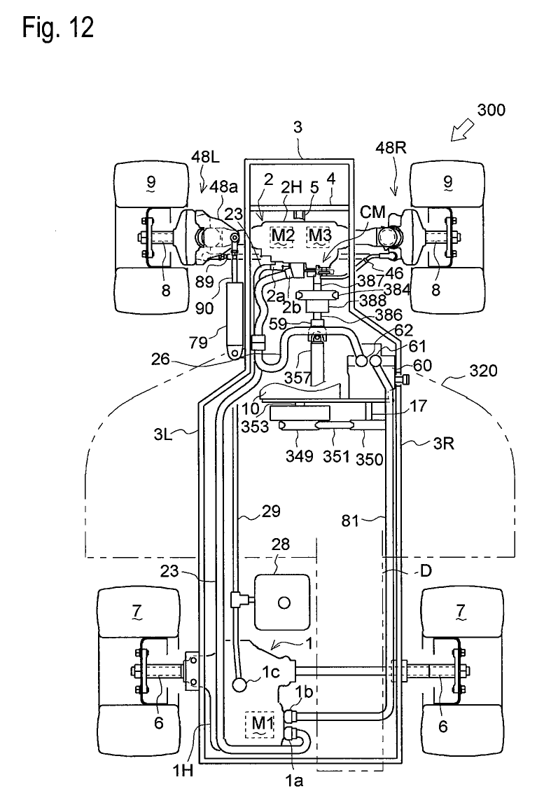

Alternative vehicle 300 equipped with a third power transmission system will be described with reference to FIGS. 11 and 12. Parts and components having the same function as those of vehicle 100 are designated by the same reference numerals. An internal combustion engine 310 is mounted on the front portion of frame 3, similar to internal combustion engine 10 of vehicle 100 or 200. Internal combustion engine 310 includes a horizontal rear output shaft 353 projecting rearward from the rear end surface of internal combustion engine 310 at a lateral middle portion between the left and right side plate portions 3L and 3R of frame 3. Internal combustion engine 310 also includes a horizontal front output shaft 382 projecting forward from the front end surface of internal combustion engine 310. The rotation direction of output shafts 353 and 382 is the same as that of output shaft 53 of internal combustion engine 10.

A vertical support plate 311 is fixed onto the rear end surface of internal combustion engine 310 and extended rightward from the portion fixed to internal combustion engine 310. Pump housing 60 is fixed onto a front surface of the rightward extended portion of support plate 311 so as to be disposed on the right side of internal combustion engine 310 and along the right side plate portion 3R of frame 3.

Pump shaft 17 projects rearward (in the fore-and-aft direction) from pump housing 60 through support plate 311 so as to be laterally aligned with output shaft 353 of internal combustion engine 310 in parallel. A pulley 349 is fixed on rear internal combustion engine output shaft 353, and a pulley 350 is fixed on the rearward projecting portion of pump shaft 17. A belt 351 is interposed between pulleys 349 and 350, so as to transmit power from internal combustion engine 310 to hydraulic pump P in pump housing 60. Radiator fan 44 in front of internal combustion engine 310 may be used for cooling pump housing 60.

Rear transaxle 1 and front transaxle 2 in vehicle 300 are configured and disposed similar to those of vehicle 100 or 200, so that the rotational direction of axles 6 relative to the fluid suction and delivery direction of hydraulic motor M1 and the rotational direction of axles 8 relative to the fluid suction and delivery direction of hydraulic motors M2 and M3 in vehicle 300 are the same as those of vehicle 100 or 200. Namely, during forward travel of vehicle 300, ports 1a and 2b serve as delivery ports, and ports 1b and 2a serve as suction ports.

The rotational direction of swash plate Pa and speed control lever 14 relative to the depression of speed control pedal 13 in vehicle 300 is reversed so as to be opposite to that of vehicle 100 or 200, in consideration that the rotation direction of pump shaft 17 in vehicle 300 is opposite to that in vehicle 100 or 200 because pump housing 60 is reversed in the fore-and-aft direction. Consequently, during forward travel of vehicle 300, port 61 serves as the delivery port, and port 62 serves as the suction port, similar to those in vehicle 100 or 200. Thus, vehicle 300 employs HST circuit HC1 with the same fluid circulation route such that hydraulic pump P supplies fluid to hydraulic motor M1 in rear transaxle 1 prior to hydraulic motors M2 and M3 in front transaxle 2 during forward travel of vehicle 300.

In this regard, pipe 81 interposed between ports 61 and 1b is extended along the right side plate of frame 3 (rightward from grass duct D), pipe 23 interposed between ports 1a and 2a is extended along the left side plate of frame 3 (leftward from grass duct D), and pipe 26 interposed between ports 62 and 2b is extended substantially laterally so as to pass through a space between the bottom end of internal combustion engine 310 and a later-discussed propeller shaft 357 below internal combustion engine 310, thereby constituting HST circuit HC1.

A mid PTO shaft 386 projects rearward from pulley 384 through an electromagnetic clutch 388, and a front PTO shaft 387 projects forward from pulley 384. A mower 320 is suspended and disposed similar to mower 20, however, mower 320 is provided on the top thereof with a mower gearbox 320d from which an input shaft projects forward toward mid PTO shaft 386 in front of gearbox 320d. Propeller shaft 357 is interposed between mid PTO shaft 386 and the forward projecting input shaft of mower gearbox 320d through respective universal joints 59.

Electromagnetic clutch 388 may be replaced with a tension clutch interposed between pulleys 383 and 384. One of PTO shafts 386 and 387 may be removed. The belt-and-pulley type working power train may be replaced with a gear train interposed between output shaft 382 and PTO shafts 386 and 387. Alternatively, a working power train for driving rotary blades in mower 320 may be configured so as to transmit power from pump shaft 17. In this case, an electromagnetic clutch may be provided onto pulley 350, or a belt tension clutch may be disposed so as to control the tension of belt 351.

While rear transaxle housing 1H and reservoir tank 28 are disposed laterally opposite to grass duct D disposed rightward in the inside of frame 3, pump housing 60 and the working power train are disposed forward from grass duct D, so as to expand a free space leftward of grass duct D.

The above-mentioned alternative arrangements adaptable to vehicle 100, such as bi-directive clutch type differential gear unit 135 in rear transaxle 1 and the combination of hydraulic motor M3 and differential gear unit 82 or 83 in front transaxle 2, are also adaptable to vehicle 300.

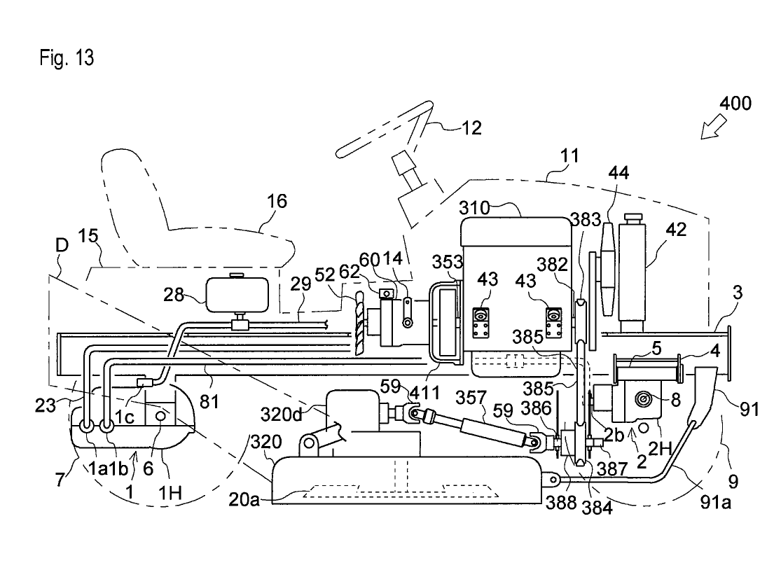

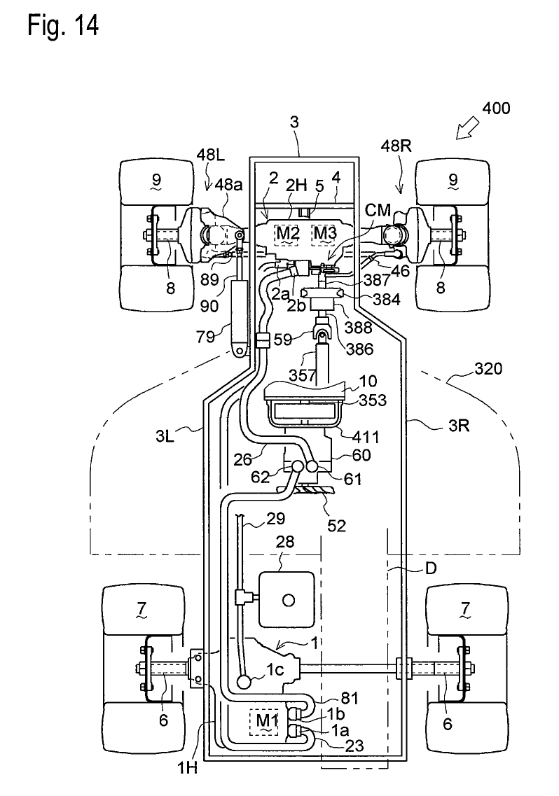

Alternative vehicle 400 will be described with reference to FIGS. 13 and 14. Parts and components having the same function as those of vehicles 100 and 300 are designated by the same reference numerals.

Arrangements of internal combustion engine 310 having opposite output shafts 353 and 382, mid and front PTO shafts 386 and 387, and the working power train interposed between front internal combustion engine output shaft 382 and PTO shafts 386 and 387 are the same as those of vehicle 300.

In vehicle 400, a support member 411 is attached onto the rear surface of internal combustion engine 310 so as to support pump housing 60. Pump shaft 17 projects forward from pump housing 60 so as to be directly connected to rear internal combustion engine output shaft 353. Therefore, the rotational direction of pump shaft 17, the fluid suction and delivery direction of hydraulic pump P and the tilt direction of movable swash plate Pa relative to the depression direction of speed control pedal 13 is the same as that of vehicle 100 and 200. Thus, vehicle 400 employs HST circuit HC1 and the piping including pipes 23, 26 and 81, as shown in FIG. 3.

In this regard, on the assumption that the arrangement and configuration of front and rear transaxles 1 and 2 are similar to those in vehicles 100, 200 and 300, pipe 26 interposed between ports 61 and 2b, pipe 81 interposed between ports 62 and 1b, and pipe 23 interposed between ports 1a and 2a are collected leftward from internal combustion engine 310 and along the left side plate portion 3L of frame 3 so as to be prevented from interfering with internal combustion engine 310 and the working power train for driving the rotary blades in mower 320, and ensure a rightward space in the inside of frame 3 for arrangement of grass duct D.

Pump shaft 17 further projects rearward from pump housing 60 so as to be fixedly provided thereon with cooling fan 52 for cooling pump housing 60.

The above-mentioned alternative arrangements adaptable to vehicles 100 and 300, such as bi-directive clutch type differential gear unit 135 in rear transaxle 1, the combination of hydraulic motor M3 and differential gear unit 82 or 83 in front transaxle 2, and the gear train between internal combustion engine output shaft 382 and PTO shafts 386 and 387, are also adaptable to vehicle 400.

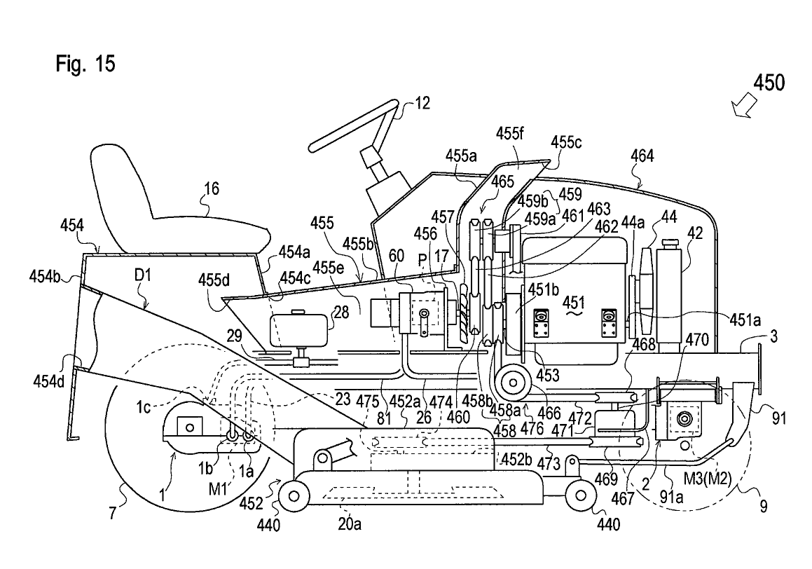

Vehicles shown in FIGS. 15 to 28 are provided with various cooling ducts. A vehicle 450 shown in FIG. 15 will be described. Vehicle 450 is an Ackerman type steered lawn tractor, comprising: frame 3; rear transaxle 1 supported by a rear portion of frame 3; front transaxle 2 supported by a front portion of frame 3; an internal combustion engine 451 supported by frame 3 between front and rear transaxles 1 and 2; pump housing 60 supported by frame 3; and a mower 452 (an example of a working device driven by internal combustion engine 451) vertically movably suspended below frame 3. Frame 3 includes a pair of left and right vertical side plates extended substantially in the fore-and-aft direction. Rear transaxle 1 and pump housing 60 are disposed in the inside space of frame 3 between the left and right side plates.

Rear transaxle 1 incorporates hydraulic motor M1 which is driven by hydraulic pump P so as to drive rear wheels 7. Front transaxle 2 incorporates left and right hydraulic motors M2 and M3 which are driven by hydraulic pump P so as to drive respective left and right front wheels 9.

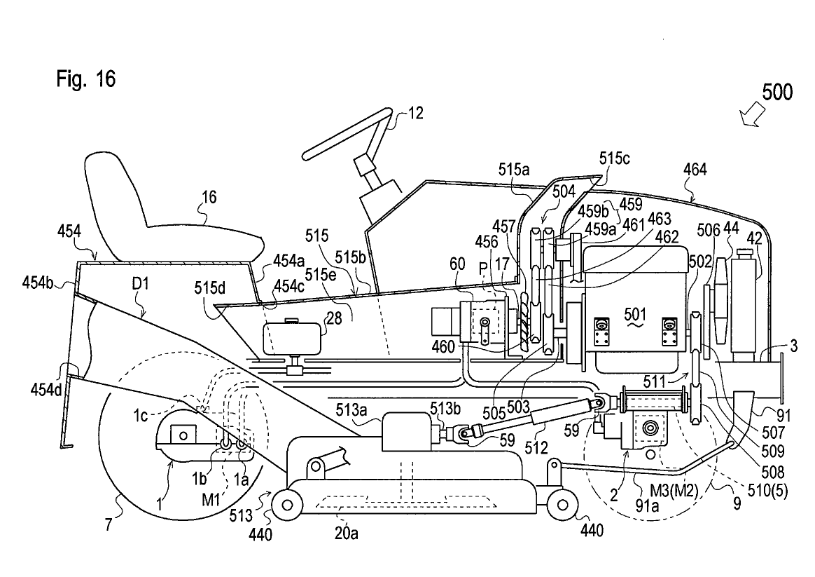

Internal combustion engine 451 is covered with a bonnet 464. A dashboard is disposed just behind bonnet 464. Steering wheel 12 is extended upwardly rearward from the dashboard. Radiator fan 44 and radiator 42 are mounted on frame 3 just in front of internal combustion engine 451 in bonnet 464. A horizontal front output shaft 451a projects forward from internal combustion engine 451 so as to be drivingly connected to radiator fan 44 through a transmission unit 44a such as a gearbox. In each of later-discussed vehicles 500, 550, 600, 650, 700, 725, 750, 775 shown FIGS. 16 to 22, an internal combustion engine has a horizontal front output shaft drivingly connected to radiator fan 44, similar to internal combustion engine 451 having front output shaft 451a.

A rear cover 454 is mounted on a rear portion of frame 3, and driver's seat 16 is mounted on the top of rear cover 454. A cooling duct 455 is fore-and-aft extended from the rear inside of bonnet 464 to the front inside of rear cover 454. Pump housing 60 and reservoir tank 28 are disposed in cooling duct 455. Reservoir tank 28 stores fluid drained from pump housing 60 and rear and front transaxles 1 and 2.

Mower 452 is disposed under frame 3 between rear wheels 7 and front wheels 9. Left and right mower hungers 91 are extended from front end portions of the left and right side plates of frame 3, respectively, and are connected to the front end of mower 20 through respective link rods 91a, thereby vertically movably suspending mower 452.

A grass collection device (not shown) can be optionally connected to a rear end portion of vehicle 450 and a grass duct D1 can be optionally interposed between mower 452 and the grass collection device, so as to collect grass mowed by mower 452. In this regard, grass duct D1 is connected at a front end thereof to a rear portion of mower 452, rear cover 454 has a hole 454d opened at a rear wall 454b thereof, and grass duct D1 is extended through hole 454d to the grass collection device. Mower 452 mows grass with its blade or blades 20a thereof and blows the mowed grass by its blower so as to send the grass to the grass collection device through grass duct D.

Description of the power transmission system and the HST circuit of vehicle 450 is omitted because they are similar to those of any of vehicles shown in FIGS. 1 to 14.

Cooling duct 455 includes a front-upper duct 455a and a rear-lower duct 455b. Top-closed rear-lower duct 455b is extended fore-and-aft, and front-upper duct 455a is extended upward from a front portion of rear-lower duct 455b. A lower half portion of front-upper duct 455a is extended vertically just behind internal combustion engine 451. An upper half portion of front-upper duct 455a is extended upwardly forward so as to be fixed to a top portion of bonnet 464. The upper portion of front-upper duct 455a is further extended upward from bonnet 464, and is provided at a top end thereof with a forwardly opened air inlet 455c. A front wall 454a of rear cover 454 is provided with a hole 454c, and rear-lower duct 455b is extended rearward through hole 454c into rear cover 454, and is provided at a rear end thereof with an air outlet 455d in rear cover 454.

The inside space of rear-lower duct 455b serves as an airway 455e. Pump housing 60 is disposed in airway 455e, and reservoir tank 28 is also disposed in airway 455e behind pump housing 60. Pump housing 60 is subjected to heat generated from hydraulic pump P therein, and reservoir tank 28 stores heated fluid from operated various hydraulic devices. Pump housing 60 is cantilevered rearward from a stay 456 mounted upright on frame 3, and reservoir tank 28 is supported on frame 3 through a support member (not shown). At least one of pump housing 60 and reservoir tank 28 may be disposed in airway 455e.

A front pulley 460 and a rear cooling fan 457 are fixed on a front portion of pump shaft 17 projecting forward from pump housing 60. Cooling fan 457 is disposed at a junction of front and rear ducts 455a and 455b. Internal combustion engine 451 is provided on a rear surface thereof with a flywheel 451b fore-and-aft opposite to radiator fan 44 and radiator 42 with respect to internal combustion engine 451. A horizontal rear output shaft 453 is extended rearward from flywheel 451b. By rotating rear output shaft 453 of internal combustion engine 451, pump shaft 17 is rotated together with cooling fan 457 so as to drive hydraulic pump P. Cooling fan 457 makes the pressure in rear-lower duct 455b, i.e., airway 455e, behind cooling fan 457 lower than the pressure in front-upper duct 455a, i.e., airway 455f, in front of cooling fan 457, so as to suck air from air inlet 455c and blow the air to air outlet 455d. The cooling air wind flows fast along airway 455e without expansion so as to be blown to pump housing 60 and reservoir tank 28 in airway 455e, thereby effectively cooling pump housing 60 and reservoir tank 28. Due to the cooling effect, vehicle 450 is durable in traveling for a long time. Even if hydraulic devices including hydraulic pump P are greatly loaded in some working conditions so as to be heated, the heated hydraulic devices and operation fluid are swiftly cooled so as to prevent their function and durability from being reduce and to prevent the fluid from being deteriorated.

A belt transmission system 465 for transmitting power of internal combustion engine 451 from output shaft 453 to pump shaft 17 is configured as follows. A double pulley 459, i.e., a front pulley 459a and a rear pulley 459b, is fore-and-aft horizontally axially pivoted on a stay 461 fixedly provided upright on frame 3 above pulley 460. A double pulley 458, a front pulley 458a and a rear pulley 458b, is fixed on fore-and-aft horizontal rear output shaft 453 of internal combustion engine 451 below double pulley 459. A belt 462 is interposed between pulleys 458b and 459a. A belt 463 is interposed between pulleys 459b and 460.

A pair of left and right pulleys 466 having coaxial lateral horizontal axes are pivoted under front pulley 458a rotatably in opposite directions. An L-shaped bracket 467 supporting an electromagnetic clutch 471 is hung down from frame 3 between the pair of pulleys 466 and front transaxle 2 in the fore-and-aft direction of vehicle 450. A mid PTO shaft 470 projects upward from clutch 471 so as to serve as a clutch input shaft, i.e., an input shaft of clutch 471. A pulley 468 is fixed on a top portion of mid PTO shaft 470. A belt 472 is looped between pulley 468 and front pulley 458a through left and right pulleys 466. In this way, a belt transmission serving as a mid PTO shaft drive train 476 is interposed between rear output shaft 453 of internal combustion engine 451 and mid PTO shaft 470 for driving mower 452. In other words, power of rear output shaft 453 of internal combustion engine 451 is distributed between mid PTO shaft 470 for driving mower 452 and pump shaft 17 of hydraulic pump P in pump unit 60.

Mid PTO shaft 470 is connected at a bottom end thereof to a clutch output pulley 469 through clutch 471. Mower 452 is provided at a top thereof with a transmission box 452a incorporating an input pulley 474 to which clutch output pulley 469 is connected through a belt 473. Input pulley 474 is fixed on a top of a vertical input shaft 475. Mower 452 is provided therein with rotary blades 20a drivingly connected to input shaft 475 through a gearbox 452b. In this way, power of mid PTO shaft drive train 476 is transmitted to clutch output pulley 469 through engaged clutch 471, and to rotary blades 20a through belt 473, input pulley 474, input shaft 475 and gearbox 452b.

Mower 452 is provided at front and rear ends of a bottom portion thereof with fore-and-aft rotatable guide wheels 440 so that mower 452 can move on a turf to evenly mow even if the turf is rough.

A vehicle 500 shown in FIG. 16 will be described. Vehicle 500 is similar to vehicle 450, excluding a drive train to mower 452 serving as a working device. Vehicle 500 is provided with an internal combustion engine 501 mounted on a front portion of frame 3. A rear output shaft 503 projects rearward from a rear end surface of internal combustion engine 501. A front output shaft 502 projects forward from a front end surface of internal combustion engine 501. Rear output shaft 503 is drivingly connected to pump shaft 17 of hydraulic pump P in pump housing 60 through a belt transmission 504 which is similar to belt transmission 465. In this regard, rear output shaft 503 is fixedly provided thereon with only a single pulley 505 constituting belt transmission 504 for driving hydraulic pump P without a pulley for driving a working device.

Vehicle 500 is provided with a cooling duct 515 including a front-upper duct 515a and a rear-lower duct 515b, similar to cooling duct 455 including front and rear ducts 455a and 455b. An air inlet 515c is provided at a top end of front-upper duct 515a, and an air outlet 515d is provided at a rear end of rear-lower duct 515b. An airway 515e is provided in rear-lower duct 515b of cooling duct 515. Pump housing 60 and reservoir tank 28 are disposed in airway 515e of cooling duct 515. Air flows through airway 515e from air inlet 515c to air outlet 515d so as to cool pump housing 60 and reservoir tank 28.

Amid PTO shaft drive train 511 is extended from front output shaft 502 to a mid PTO shaft 510 for driving a mower 513 so as to branch from the drive train from front output shaft 502 to radiator fan 44. Preferably, a tension clutch (not shown) is interposed between pulleys 507 and 508. Due to the tension clutch, belt 509 is selectively tightened for transmitting power or loosened for shutting off power.

Mid PTO shaft 510 is fore-and-aft extended so as to serve as center pivot 5 of front transaxle 2. Mid PTO shaft 510 projects rearward so as to be drivingly connected to a propeller shaft 512 through front universal joint 59. Propeller shaft 512 is extended rearward and is drivingly connected through rear universal joint 59 to an input shaft 513b of mower 513. Input shaft 513b projects forward from a mower gearbox 513a which is provided at a top of mower 513 so as to drive rotary blades 20a. Propeller shaft 512 is slanted rearwardly downward because mid PTO shaft 510 is higher than input shaft 513b of mower 513.

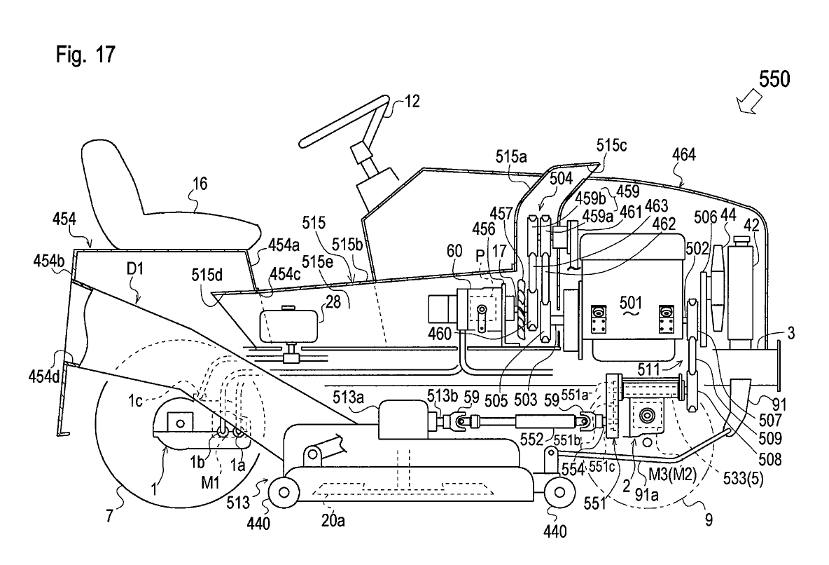

A vehicle 550 shown in FIG. 17 will be described. Vehicle 550 is provided with a fore-and-aft horizontally extended shaft 533 serving as center pivot 5 of front transaxle 2, and with mid PTO shaft drive train 511 extended from front output shaft 502 of internal combustion engine 501 to shaft 533, similar to those of vehicle 500.

The only distinctive point of vehicle 550 from vehicle 500 is a drive train between shaft 533 and input shaft 513b of mower 513. In this regard, a gearbox 551 is disposed just behind front transaxle 2. Gearbox 551 incorporates a top input gear 551a, a vertically middle counter gear 551b meshing with input gear 551a, and a bottom output gear 551c meshing with counter gear 551b. Input gear 551a is fixed on a rear end of shaft 533. Output gear 551c is fixed on a front end of a horizontal mid PTO shaft 554. Mid PTO shaft 554 projects rearward from gearbox 551.

A propeller shaft 552 is interposed between mid PTO shaft 554 and input shaft 513b of mower 513 through front and rear universal joints 59. Shaft 533 serving as center pivot 5 is higher than input shaft 513b of mower 513, however, due to the vertical gear train including gears 551a, 551b and 551c in gearbox 551, mid PTO shaft 554 is lowered to be substantially as high as input shaft 513b, so that propeller shaft 552 is extended substantially horizontally so as to maximize its power transmission efficiency.

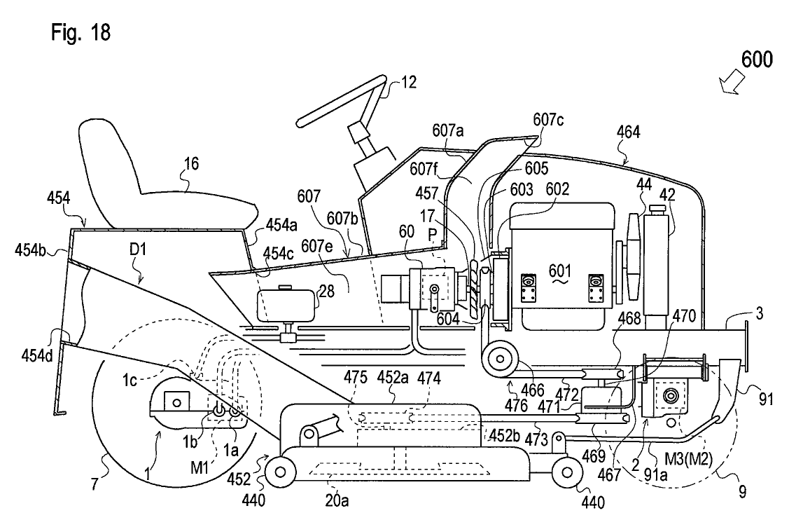

A vehicle 600 shown in FIG. 18 will be described. Vehicle 600 is similar to vehicle 450, excluding a drive train to hydraulic pump P. In vehicle 600, an internal combustion engine 601 is provided with a rear flywheel 602 and a horizontal rear output shaft 603 projecting rearward from flywheel 602. Horizontal pump shaft 17 projects forward from pump housing 60 coaxially to output shaft 603, and is directly connected to output shaft 603 without a belt transmission.

A pulley 604 and cooling fan 457 are fixed on the projecting front portion of pump shaft 17. Pulley 604 is disposed in front of cooling fan 457. Mid PTO shaft drive train 476 is extended from pulley 604 replacing pulley 458a to mid PTO shaft 470, similar to that of vehicle 450.

A cooling duct 607, including a front-upper duct 607a, a rear-lower duct 607b, a front-top air inlet 607c and a rear air outlet 607d, is similar to cooling duct 455 including front and rear ducts 455a and 455b, air inlet 455c and air outlet 455d. An airway 607f is provided in front-upper duct 607a from air inlet 607c, and an airway 607e is provided in rear-lower duct 607b to air outlet 607d. Cooling fan 457 is disposed in a front portion of rear-lower duct 607b just under front-upper duct 607a, i.e., at a transference position from airway 607f to airway 607e. In rear-lower duct 607b, pump housing 60 is disposed just behind cooling fan 457, and reservoir tank 28 is disposed adjacent to air outlet 607d. A horizontally axial conic (bell-shaped) cover 605 is interposed between the rear end of internal combustion engine 601 and the front end of pump housing 60 so as to house flywheel 602, pulley 604 and cooling fan 457. Cooling fan 457 radially projects from cover 605 so as to blow the air from air inlet 607c rearward to air outlet 607d so as to cool pump housing 60 and reservoir tank 28.

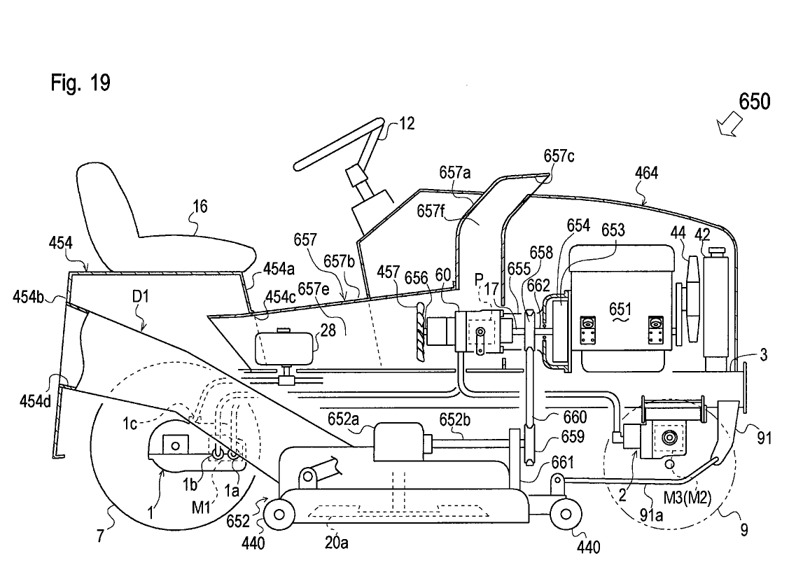

A vehicle 650 shown in FIG. 19 will be described. Vehicle 650 is similar to vehicle 600, excluding a position of cooling fan 457 and a drive train between an internal combustion engine 651 and a mower 652. Internal combustion engine 651 has a rear flywheel 653 and a horizontal rear output shaft 662 projecting rearward from flywheel 653. Horizontal pump shaft 17 projects forward from pump housing 60 so as to be coaxially connected to rear output shaft 662. Internal combustion engine 651 is provided on a rear end surface thereof with a flywheel cover 654 housing flywheel 653, and a cover 655 is extended rearward from flywheel cover 654 and is fixed to the front end of pump housing 60 so as to enclose pump shaft 17.

With regard to the position of cooling fan 457, a horizontal fan shaft 656 is coaxially connected to horizontal pump shaft 17 in pump housing 60, and projects rearward from pump housing 60 so as to be fixedly provided thereon with a cooling fan 457. Pump shaft 17 as itself may be extended rearward to serve as fan shaft 656.

A cooling duct 657, including a front-upper duct 657a, a rear-lower duct 657b, a front-top air inlet 657c and a rear air outlet 657d, is similar to cooling duct 607 including front and rear ducts 607a and 607b, air inlet 607c and air outlet 607d. An airway 657f is provided in front-upper duct 657a from air inlet 657c, and an airway 657e is provided in rear-lower duct 657b to air outlet 657d. Cooling fan 457 is disposed in rear-lower duct 657b behind the bottom of front-upper duct 657a. Cooling fan 457 absorbs the air flowing from air inlet 657c through airway 657f so as to cool pump housing 60, and blows the air rearward to reservoir tank 28 in rear-lower duct 657b adjacent to air outlet 657d. In this regard, rear-lower duct 657b is gradually narrowed rearward to air outlet 657d. Cooling fan 457 is disposed in a considerably rearward portion of rear-lower duct 657b, so as to have a narrow gap between the outer periphery of cooling fan 457 and the inner periphery of rear-lower duct 657b, and has a rotary axis extended along the air flow in airway 657e, thereby advantageously concentrating the air therethrough in airway 657e, and improving the cooling effect to reservoir tank 28.

With regard to the drive train from internal combustion engine 651 to mower 652, a pulley 658 is fixed on forward projecting pump shaft 17. Mower 652 is provided on a top portion thereof with a gearbox 652a for driving rotary blades 20a, and on a front end portion thereof with an upright stay 661. A horizontal input shaft 652b is extended forward from gearbox 652a and is journalled by stay 661. A front end of input shaft 652b projects forward from stay 661 just below pulley 658, and a pulley 659 is fixed on the front end of input shaft 652b. A belt 660 is vertically looped between upper and lower pulleys 658 and 659. A tension clutch (not shown) may be preferably provided to selectively tighten or loosen belt 660.

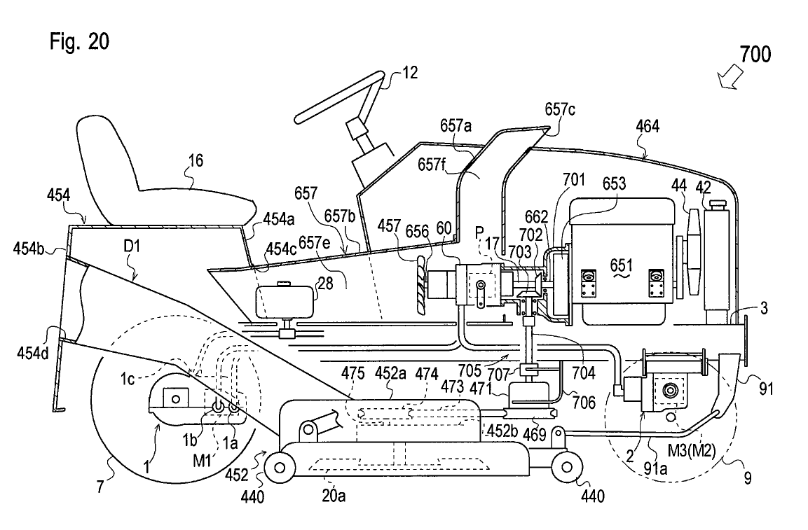

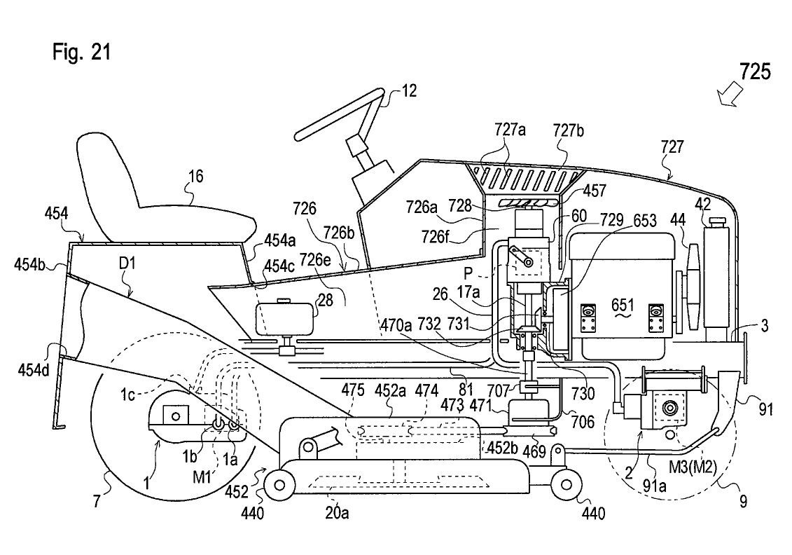

A vehicle 700 shown in FIG. 20 will be described. Vehicle 700 is similar to vehicle 650, excluding a drive train structure between internal combustion engine 651 and mower 452. A housing 701 is fixed between the rear end of internal combustion engine 651 and the front end of pump housing 60. Housing 701 is formed therein with front and rear chambers. The front chamber of housing 701 serves as a flywheel chamber incorporating flywheel 653 of internal combustion engine 651. The rear chamber of housing 701 serves as a gear chamber, in which a bevel gear 702 is fixed on horizontal pump shaft 17 and meshes with a bevel gear 703. Bevel gear 703 is fixed on a top end of a vertical clutch input shaft 704. Clutch input shaft 704 is extended vertically upward from electromagnetic clutch 471 disposed below frame 3, and is inserted into the rear chamber of housing 701 so as to be fixedly provided thereon with bevel gear 703. In comparison with the belt transmission as shown in vehicle 650, bevel gears 702 and 703 are advantageous in reduction of power loss.

A bracket 706 is extended downward from frame 3 so as to support clutch 471 at a bottom portion thereof, and to support a vertically intermediate portion of clutch input shaft 704 through a bearing member 707. The belt transmission including belt 473 is interposed between clutch 469 and input shaft 475 of mower 452, similar to that of vehicle 450.

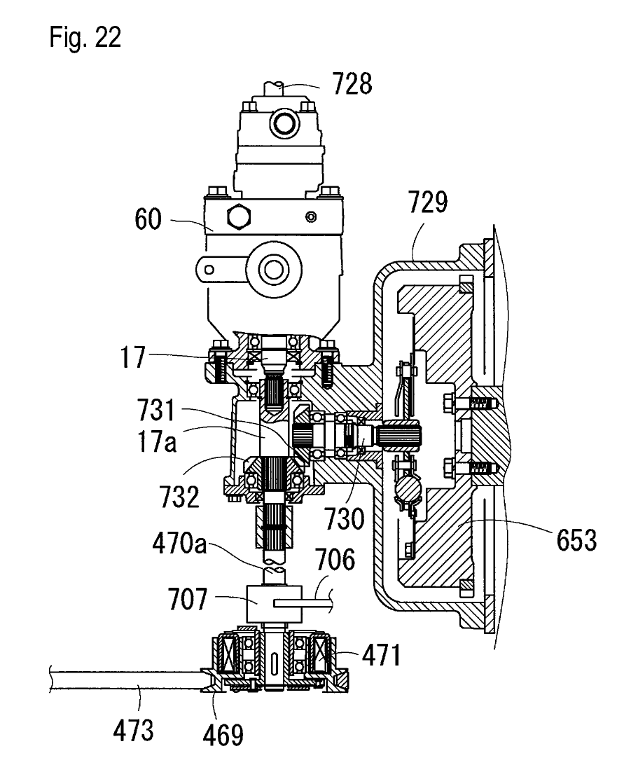

A vehicle 725 shown in FIGS. 21 and 22 will be described. Vehicle 725 is similar to vehicle 700, excluding a structure of a cooling duct 726, a position of cooling fan 457, a structure for supporting pump housing 60, and a drive train structure between internal combustion engine 651 and hydraulic pump P in pump housing 60.

Cooling duct 726 includes a front-upper duct 657a and a rear-lower duct 657b, similar to cooling duct 657 including front and rear ducts 657a and 657b. The distinctive point of cooling duct 726 from cooling duct 657 is a shape of front-upper duct 726a and an air inlet structure provided on a top of front-upper duct 726a.

Front-upper duct 657a is vertically extended. In comparison with the foresaid front-upper ducts, front-upper duct 657a is horizontally wide so as to incorporate pump housing 60. A bonnet 727 incorporates internal combustion engine 651, radiator fan 44 and radiator 42, similar to bonnet 464, and an upwardly closed funnel-shaped air inlet 727b is formed between the top end of front-upper duct 657a and a top surface portion of bonnet 727, thereby eliminating the portion of the cooling duct projecting upward from the bonnet to obstruct an operator's view. Vent slits 727a are opened at opposite side surfaces of bonnet 727 in air inlet 727b. In comparison with the foresaid front-upper ducts, front-upper duct 657a is advantageous for the view of an operator sitting on seat 16 because it has no portion projecting upward from the bonnet to obstruct the operator's view. Further, vent slits 727a are opened sidewise so as to prevent rainwater, mud and dirt from entering cooling duct 726.

Pump housing 60 is disposed vertically in front-upper duct 726a, a bottom end of pump shaft 17 projects downward from a bottom end of pump housing 60, and an extension shaft 17a is coaxially and rotatably integrally extended vertically downward from the bottom end of pump shaft 17. Instead of extension shaft 17a, pump shaft 17 as itself may be extended outward from pump housing 60. Extension shaft 17a extended coaxially from pump shaft 17 as shown in FIG. 22 may serve as any pump shaft 17 extended from pump housing 60 shown in drawings other than FIG. 21. A fan shaft 728 is connected coaxially to pump shaft 17 in pump housing 60, and projects upward from pump housing 60. Pump shaft 17 as itself may serve as fan shaft 728. Cooling fan 457 is fixed on the top end of fan shaft 728 immediately below air inlet 727b so as to blow down the air from air inlet 727b into an airway 727f provided in front-upper duct 727a, thereby cooling pump housing 60.

A housing 729 is fixed between the rear end of internal combustion engine 651 and the bottom end of pump housing 60. Housing 729 is formed therein with front and rear chambers. The front chamber of housing 729 serves as a flywheel chamber incorporating flywheel 653 of internal combustion engine 651. A horizontal rear output shaft 730 of internal combustion engine 651 is extended rearward from flywheel 653, and is inserted at a rear end thereof into the rear chamber of housing 729. The rear chamber of housing 729 serves as a gear chamber. In the gear chamber of housing 729, a bevel gear 731 is fixed on the rear end of rear output shaft 730, and a bevel gear 732 is fixed on vertical pump shaft 17 extended downward from pump housing 60. Bevel gears 731 and 732 mesh each other so as to serve as a gear train for transmitting power of internal combustion engine 651 to hydraulic pump P in pump housing 60.

In vehicle 725, vertical pump shaft 17 is further extended downward from housing 729, and a clutch input shaft 470a is extended vertically upward from electromagnetic clutch 471 below frame 3. Pump shaft 17 and clutch input shaft 470a are coaxially and rotatably integrally connected to each other. Alternatively, pump shaft 17 may be extended further downward and inserted into clutch 471 so as to serve as a clutch input shaft of clutch 471. Bracket 706 is extended downward from frame 3 so as to support clutch 471 and clutch input shaft 470a (or pump shaft 17).

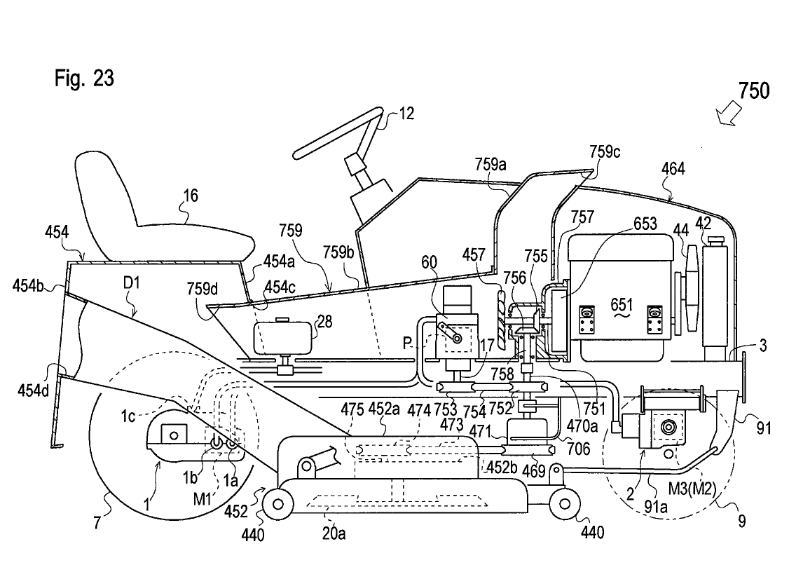

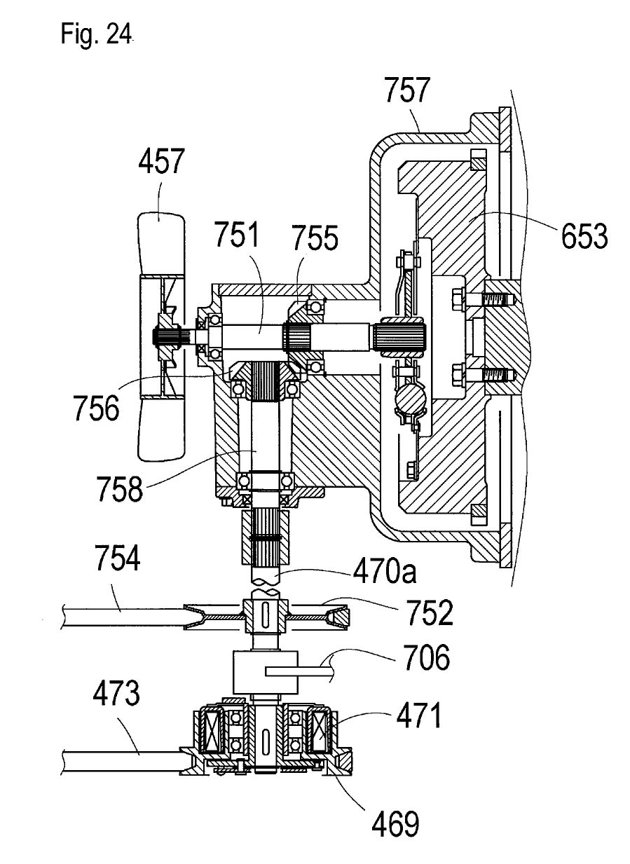

A vehicle 750 shown in FIGS. 23 and 24 will be described. Vehicle 750 is similar to vehicle 700, excluding positions of cooling fan 457 and pump housing 60. A cooling duct 759, including a front-upper duct 759a, a rear-lower duct 759b, a front-top air inlet 759c and a rear air outlet 759d, is similar to cooling duct 657 including front and rear ducts 657a and 657b and air inlet 657c and outlet 657d.

A housing 757 is fixed between the rear end of internal combustion engine 651 and a bottom surface of rear-lower duct 759b (or a top surface of frame 3). Housing 757 is formed therein with front and rear chambers. The front chamber of housing 757 serves as a flywheel chamber incorporating flywheel 653 of internal combustion engine 651. A horizontal rear output shaft 751 of internal combustion engine 651 is extended rearward from flywheel 653, and is inserted into the rear chamber of housing 729. The rear chamber of housing 729 serves as a gear chamber. In the gear chamber of housing 729, a bevel gear 755 is fixed on rear output shaft 751, and a bevel gear 756 is fixed on a top of a vertical transmission shaft 758. Transmission shaft 758 is extended downward from a bottom end of housing 757 on the bottom of rear-lower duct 759b, and clutch input shaft 470a is extended vertically upward from electromagnetic clutch 471 so as to be coaxially and rotatably integrally connected to transmission shaft 758. Alternatively, transmission shaft 758 may be extended vertically downward to be inserted into clutch 471 so as to serve as a clutch input shaft of clutch 471. Clutch input shaft 470a (or transmission shaft 758) is supported together with electromagnetic clutch 471 by bracket 706. In the gear chamber of housing 757, bevel gears 755 and 756 mesh each other so as to serve as a gear train for transmitting power of internal combustion engine 651 to mower 452 through clutch 471.

Cooling fan 457 is fixed on a rear end of rear output shaft 751 projecting rearward from housing 757. Pump housing 60 is disposed in rear-lower duct 759b just behind cooling fan 457 so as to extend pump shaft 17 vertically. Pump housing 60 is fixed at the bottom thereof to the bottom surface of rear-lower duct 759b. Vertical pump shaft 17 is extended downward from the bottom of pump housing 60 and the bottom of rear-lower duct 759b, and is fixedly provided on a bottom end thereof with a pulley 753. A pulley 752 is fixed on an intermediate portion of clutch input shaft 470a (or transmission shaft 758) just in front of pulley 753. A belt 754 is substantially horizontally looped between pulleys 752 and 753. Therefore, the gear train including bevel gears 755 and 756 also transmits power to pump shaft 17 of hydraulic pump P through the belt transmission including belt 754 and pulleys 752 and 753.

Cooling fan 457 is disposed at a rear end position of a bottom space of front-upper duct 759c, so as to absorb the air flowing downward from air inlet 759c and, blow the air rearward, thereby cooling pump housing 60 and reservoir tank 28.

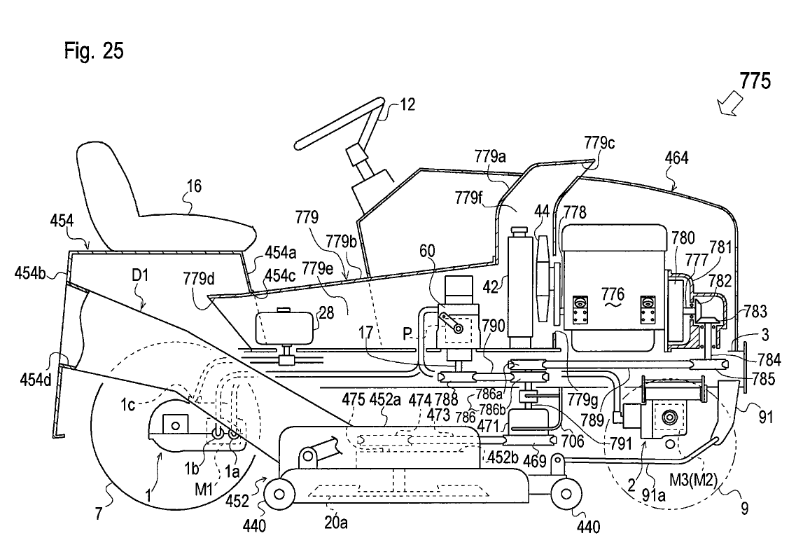

A vehicle 775 shown in FIG. 25 will be described. Vehicle 775 is similar to vehicle 750, excluding a mounting direction of an internal combustion engine 776, a device for cooling pump housing 60 and reservoir tank 28, and a drive train for distributing power of internal combustion engine 776 between hydraulic pump P and mower 452.

A cooling duct 779, including a front-upper duct 779a, a rear-lower duct 779b, a front-top air inlet 779c and a rear air outlet 779d, is similar to cooling duct 759 including front and rear ducts 759a and 759b and air inlet 759c and outlet 759d. An airway 779f is provided in front-upper duct 779a, and an airway 779e is provided in rear-lower duct 779b. In rear-lower duct 779b, pump housing 60 is fixed on a bottom surface of rear-lower duct 779b so as to extend vertical pump shaft 17 downward from the bottom of pump housing 60 and the bottom of rear-lower duct 779b, similar to that of vehicle 750. Cooling duct 779 is formed at a front end portion thereof with a front opening 779g.

Internal combustion engine 776 corresponds to fore-and-aft reversed internal combustion engine 451 or 651. In this regard, a horizontal rear output shaft 778 of internal combustion engine 776, corresponding to front output shaft 451a of internal combustion engine 451, is extended rearward from internal combustion engine 776 into cooling duct 779, and is drivingly connected to radiator fan 44 in cooling duct 779 through opening 779g. Radiator 42 is disposed immediately behind radiator fan 44. Pump housing 60 is mounted on a bottom surface of rear-lower duct 779b (or a top surface of frame 3) just behind radiator 42 so as to extend vertical pump shaft 17 downward from the bottom of pump housing 60 and the bottom of rear-lower duct 779b, similar to that of vehicle 750. Reservoir tank 28 is disposed in rear-lower duct 779b adjacent to air outlet 779b. Due to radiator fan 44, the downward airflow in airway 779f from air inlet 779c is turned rearward in airway 779e to air outlet 779d through radiator 42, pump housing 60 and reservoir tank 28. In this way, vehicle 775 uses existing radiator fan 42 for cooling pump housing 60 and reservoir tank 28, instead of additional cooling fan 457, thereby reducing the number of components.

A housing 781 is fixed on a front end of internal combustion engine 776, similar to housing 757 fixed on the rear end of internal combustion engine 651. Housing 781 is formed therein with front and rear chambers. The rear chamber of housing 781 serves as a flywheel chamber incorporating a flywheel 780 of internal combustion engine 776. A horizontal front output shaft 777 of internal combustion engine 776 is extended forward from flywheel 780, and is inserted into the front chamber of housing 781. The front chamber of housing 781 serves as a gear chamber. In the gear chamber of housing 781, a bevel gear 782 is fixed on a front end of front output shaft 777, and a bevel gear 783 is fixed on a top of a vertical shaft 784 and meshes with bevel gear 782. Shaft 784 is extended downward from a bottom end of housing 781 and a top surface of frame 3 so as to be fixedly provided thereon with a pulley 785.

Electromagnetic clutch 471 is disposed below frame 3 between housing 781 and pump housing 60 in the fore-and-aft direction of vehicle 775. A vertical clutch input shaft 791 is extended upward from clutch 471, and is supported together with clutch 471 by bracket 706 extended downward from frame 3. A double pulley 786, including an upper pulley 786a and a lower pulley 786b, is fixed on an upper portion of clutch input shaft 791. Upper pulley 786a is connected to pulley 785 through a horizontally extended belt 789. A pulley 788 is fixed on a bottom end of pump shaft 17, and is connected to lower pulley 786b through a horizontally extended belt 790. In this way, the gear train including bevel gears 782 and 783 transmits power of internal combustion engine 776 to clutch input shaft 791 through pulleys 785 and 786a and belt 789, and the power of clutch input shaft 791 is distributed between hydraulic pump P and mower 452. More specifically, the power of clutch input shaft 791 is transmitted to mower 452 through clutch 471 and the belt transmission including belt 473 and pulleys 469 and 474, and is also transmitted to hydraulic pump P through the belt transmission including belt 790 and pulleys 786b and 788.

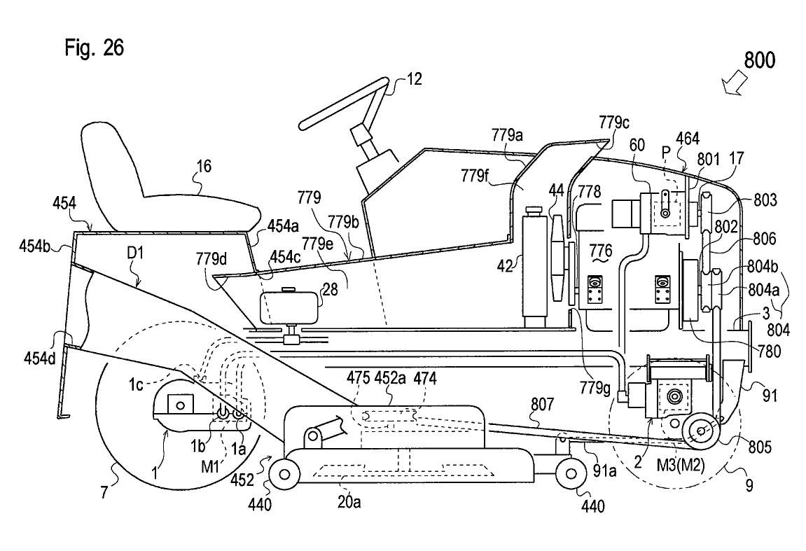

A vehicle 800 shown in FIG. 26 will be described. Vehicle 800 is similar to vehicle 775, in which internal combustion engine 776 is provided with radiator fan 44 and radiator 42 rearward therefrom, excluding a position of pump housing 60 and a drive train for transmitting power of internal combustion engine 776 to hydraulic pump P and mower 452.

Cooling duct 779 is extended rearward from internal combustion engine 776, similar to that of vehicle 775. However, pump housing 60 is not disposed in airway 779e or 779f of cooling duct 779. Pump housing 60 is cantilevered rearward from a stay 801 extended downward from a top portion of bonnet 464 on one of left and right sides of internal combustion engine 776. In other words, pump housing 60 overlaps internal combustion engine 776 when vehicle 800 is viewed in side. A horizontal front output shaft 802 projects forward from flywheel 780 so as to be fixedly provided thereon with a double pulley 804 including a front pulley 804a and a rear pulley 804b. Horizontal pump shaft 17 projects forward from stay 801 so as to be fixedly provided on a front end thereof with a pulley 803. A belt 806 is looped vertically between pulleys 803 and 804b, so as to constitute a very short belt transmission interposed between front output shaft 802 of internal combustion engine 776 and pump shaft 17 of hydraulic pump P.

Similar to radiator fan 44 of vehicle 775, radiator fan 44 absorbs air from air inlet 779c into airway 779f, blows air rearward through radiator 42 to reservoir tank 28. On the other hand, pump housing 60 is cooled together with internal combustion engine 776 by air introduced into bonnet 464 through a grill or grills formed in a front surface or side surfaces of bonnet 464.

A belt 807 is looped between horizontally axial pulley 804a on front output shaft 802 of internal combustion engine 776 and vertically axial input pulley 474 of mower 452. A tension clutch (not shown) may be provided to selectively tighten or loosen belt 807. Vehicle 800 is provided with a pair of left and right pulleys 805 below pulley 804a so as to guide and bend left and right intermediate portions of belt 807 between pulleys 804a and 474, so that the left and right portions of belt 807 between pulleys 804a and 805 are extended substantially vertically, and the left and right portions of belt 807 between pulleys 805 and 474 are extended substantially horizontally (in this embodiment, slightly upwardly rearward slantwise). Therefore, vehicle 800 advantageously has such a belt transmission for transmitting power of internal combustion engine 776 to mower 452 with the pulleys and belt reduced in number.

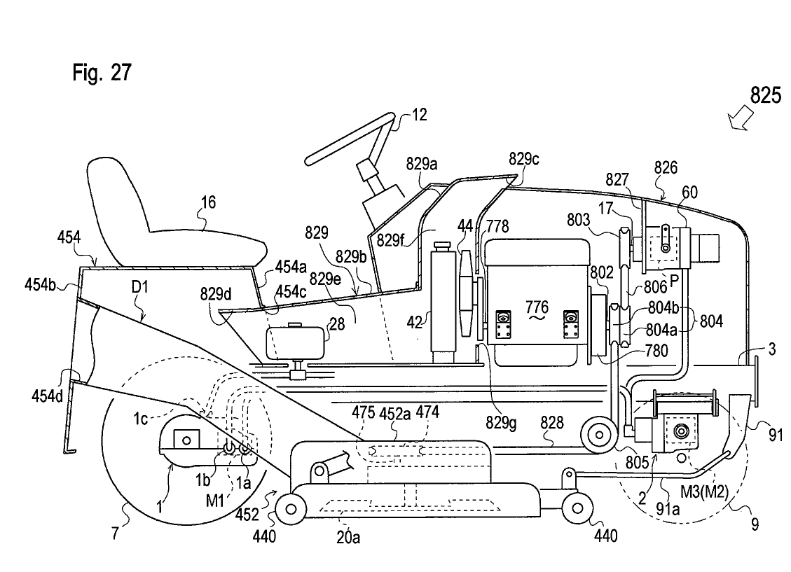

A vehicle 825 shown in FIG. 27 will be described. Vehicle 825 is similar to vehicle 800, in which internal combustion engine 776 is provided with radiator fan 44 and radiator 42 rearward therefrom, excluding relative positions of pump housing 60 and internal combustion engine 776 and a fore-and-aft shortened cooling duct 829.

In vehicle 825, internal combustion engine 776 is offset rearward from pump housing 60 so as to have a space for the drive train from front output shaft 802 to pump shaft 17 between the front end of internal combustion engine 776 and the rear end of pump housing 60. In this regard, vehicle 825 is provided with a bonnet 826 covering pump housing 60 and internal combustion engine 776. A stay 827 is extended downward from a top surface portion of bonnet 826, and pump housing 60 is cantilevered forward from stay 827. Horizontal pump shaft 17 projects rearward from stay 827, and pulley 803 is fixed on a rear end of pump shaft 17. Pump shaft 17 is drivingly connected to front output shaft 802 of internal combustion engine 776 through the belt transmission, which is similar to that of vehicle 800, that is, in which belt 806 is looped vertically between pulley 803 and front pulley 804a of double pulley 804 fixed on front output shaft 802 of internal combustion engine 776.

A belt 828 is looped between rear pulley 804b of double pulley 804 and input pulley 474 of mower 452. The pair of left and right pulleys 805 guide and bend left and right intermediate portions of belt 828 between pulleys 804b and 474, so that the left and right portions of belt 828 between pulleys 804b and 805 are extended substantially vertically, and the left and right portions of belt 828 between pulleys 805 and 474 are extended substantially horizontally. In comparison of vehicle 825 with vehicle 800, belt 828 of vehicle 825 is shorter than belt 806 of vehicle 800 so as to increase the power transmission efficiency, because vehicle 825 includes internal combustion engine 776 offset rearward from pump housing 60 when viewed in side whereas vehicle 800 includes internal combustion engine 776 overlapping pump housing 60 when viewed in side.

A cooling duct 829, including a front-upper duct 829a, a rear-lower duct 829b, a front-top air inlet 829c and a rear air outlet 829d, is similar to cooling duct 779 including front and rear ducts 779a and 779b and air inlet 779c and outlet 779d. An airway 829f is provided in front-upper duct 829a, and an airway 829e is provided in rear-lower duct 829b. Radiator 42 and radiator fan 44 are disposed in cooling duct 829 at a junction portion of ducts 829a and 829b, and rear output shaft 778 of internal combustion engine 776 is drivingly connected to radiator fan 44 through an opening 829g formed at a front end of cooling duct 829. Reservoir tank 28 is disposed in rear-lower duct 829b adjacent to air outlet 829d.

As internal combustion engine 776 is shifted rearward, rear-lower duct 829b becomes fore-and-aft short so that radiator fan 44 approaches reservoir tank 28. In other words, airway 829e between radiator fan 44 and reservoir tank 28 is short. Therefore, radiator fan 44 leads the air downward in airway 829f from air inlet 829c and blows the air into short airway 829e through radiator 42 so as to increase the efficiency of cooling reservoir tank 28. Pump housing 60 is cooled together with internal combustion engine 776 by air introduced into bonnet 464 through a grill or grills formed in a front surface or side surfaces of bonnet 464.

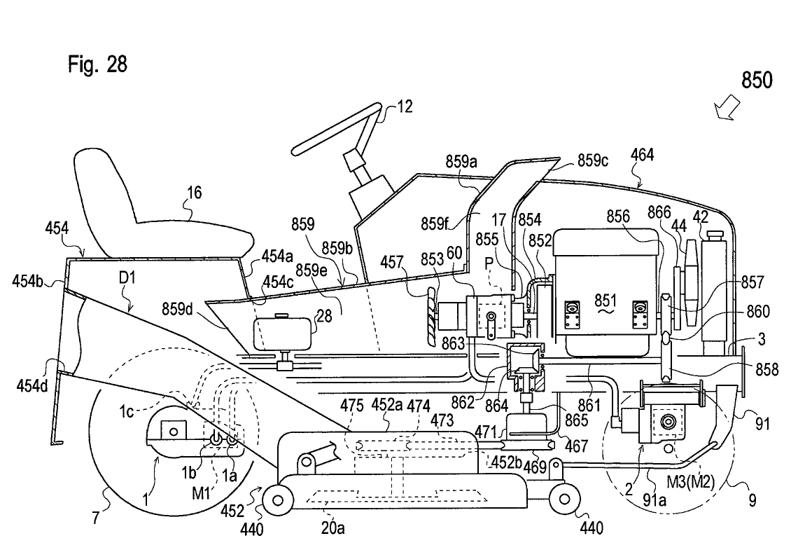

A vehicle 850 shown in FIG. 28 will be described. In vehicle 850, reservoir tank 28 and pump housing 60 with cooling fan 457 are disposed in a cooling duct 859, and an internal combustion engine 851 has a front output shaft for driving mower 452 and a rear output shaft for driving hydraulic pump P.

Cooling duct 859 includes a front-upper duct 859a and a rear-lower duct 859b. Front-upper duct 859a projects upward from bonnet 464 so as to have a front-top air inlet 859c. Rear-lower duct 859b has a rear open end as an air outlet 859d. An airway 859f is provided in front-upper duct 859a, and an airway 859e is provided in rear-lower duct 859b. Pump housing 60 is disposed in cooling duct 859 at a junction portion of ducts 859a and 859b. Reservoir tank 28 is disposed in rear-lower duct 859b adjacent to air outlet 859d. Cooling fan 457 is fixed on a horizontal fan shaft 853 projecting rearward from pump housing 60 so as to face reservoir tank 28. Cooling fan 457 absorbs air flowing from air inlet 859c into airway 859f so as to cool pump housing 60, and then blows air rearward so as to cool reservoir tank 28.

Internal combustion engine 851 disposed in front of cooling duct 859 has a horizontally axial rear flywheel 852. A flywheel housing 854 is fixed onto the rear end surface of internal combustion engine 851 so as to incorporate flywheel 852. Horizontal pump shaft 17 projects forward from pump housing 60 through a front end of cooling duct 859, and is drivingly connected coaxially to flywheel 852 so as to minimize power loss. A cover 855 is interposed between pump housing 60 and flywheel housing 854 so as to cover pump shaft 17.

A horizontal front output shaft 856 projects forward from internal combustion engine 851 and is drivingly connected to radiator fan 44 through a transmission casing 866. Radiator 42 is disposed in front of radiator fan 44. A drive train for driving mower 452 is interposed between front output shaft 856 and mower input pulley 474 through electromagnetic clutch 471. In this regard, pulley 857 is fixed on front output shaft 856 between the front end of internal combustion engine 851 and transmission casing 866. A fore-and-aft horizontal shaft 861 is disposed just below internal combustion engine 851. A pulley 858 is fixed on a front end of shaft 861 just below pulley 857, and a belt 860 is vertically looped between upper and lower pulleys 857 and 858.

Electromagnetic clutch 471 is supported by bracket 467, similar to that of vehicle 450. A gearbox 862 is supported above clutch 471. A rear end of shaft 861 is disposed in gearbox 863, and is fixedly provided thereon with a bevel gear 863. A vertical clutch input shaft 865 is extended upward from clutch 471. A top end of clutch input shaft 865 is disposed in gearbox 862, and is fixedly provided thereon with a bevel gear 864 meshing with bevel gear 863. Clutch output pulley 469 is disposed immediately below clutch 471, and belt 473 is looped substantially horizontally between clutch output pulley 469 and mower input pulley 474, similar to that of vehicle 450. In this way, the drive train for driving rotary blades 20a of mower 452 is interposed between front output shaft 856 of internal combustion engine 851 and mower input shaft 475 of mower 452, so as to include the upstream side belt transmission having substantially horizontal belt 860, the bevel gear train having bevel gears 863 and 864, and the downstream side belt transmission having substantially horizontal belt 473.

It is further understood by those skilled in the art that the foregoing description is a preferred embodiment of the disclosed apparatus and that various changes and modifications may be made in the invention without departing from the spirit and scope thereof defined by the following claims.

What is claimed is:

1. A hydraulic drive vehicle comprising:
a vehicle frame;
a bonnet supported on one of front and rear portions of the vehicle frame, and provided therein with a first space;
a prime mover disposed in the first space;
a hydraulic transaxle driven by the prime mover;
a seat supported on the other of the front and rear portions of the vehicle frame, and provided therebelow with a second space;
a reservoir tank fluidly connected to the hydraulic transaxle;
a cooling fan driven by the prime mover; and
a cooling duct disposed in the second space, wherein the cooling fan and the reservoir tank are disposed in the cooling duct so that the cooling fan cools the reservoir tank.

2. The hydraulic drive vehicle according to claim 1, further comprising:
a hydraulic pump for driving the hydraulic transaxle, wherein the hydraulic pump is disposed in the cooling duct so as to be cooled by the cooling fan.

3. The hydraulic drive vehicle according to claim 1, wherein the cooling duct includes an air inlet opened outside of the bonnet.

4. A hydraulic pump cooling system of a working vehicle comprising:
a prime mover;
a hydraulic pump driven by the prime mover;
a hydraulic transaxle driven by the hydraulic pump;
a working device driven by the prime mover;
a cooling fan driven by the prime mover; and
a cooling duct in which the cooling fan and the hydraulic pump are disposed so that the cooling fan cools the hydraulic pump.

5. The hydraulic pump cooling system of a working vehicle according to claim 4, wherein the prime mover has a first output shaft extended toward the cooling duct so as to drive the hydraulic pump and the cooing fan.

6. The hydraulic pump cooling system of a working vehicle according to claim 5, wherein a drive train for driving the working device is extended from the first output shaft to the outside of the cooling duct.

7. The hydraulic pump cooling system of a working vehicle according to claim 5, wherein the prime mover has a second output shaft opposite to the first output shaft, and wherein a drive train for driving the working device is extended from the second output shaft.

8. The hydraulic pump cooling system of a working vehicle according to claim 5, wherein the hydraulic pump has a pump shaft coaxially connected to the first output shaft.

9. The hydraulic pump cooling system of a working vehicle according to claim 5, wherein the hydraulic pump has a pump shaft drivingly connected to the first output shaft through a transmission device.

10. The hydraulic pump cooling system of a working vehicle according to claim 5, wherein the hydraulic pump has a pump shaft drivingly connected to the first output shaft through a gear train.

11. The hydraulic pump cooling system of a working vehicle according to claim 10, wherein the pump shaft is disposed perpendicular to the first output shaft, and the gear train distributes power of the first output shaft between the pump shaft and the working device.

12. A reservoir tank cooling system of a hydraulic drive vehicle comprising:
an internal combustion engine;
a radiator and a radiator fan drivingly connected to the internal combustion engine;
a hydraulic transaxle driven by the internal combustion engine;
a reservoir tank fluidly connected to the hydraulic transaxle;
a cooling duct in which the radiator fan and the reservoir tank are disposed so that the radiator fan cools the radiator and the reservoir tank.

13. The reservoir tank cooling system of a hydraulic drive vehicle according to claim 12, further comprising:
a hydraulic pump for driving the hydraulic transaxle, wherein the hydraulic pump is separated from the hydraulic transaxle, and is disposed in the cooling duct so as to be cooled by the radiator fan.

14. A lawn tractor comprising:
a bonnet;
a prime mover covered with the bonnet;
a hydraulic transaxle driven by the prime mover;
a mower driven by the prime mover;
a seat;
a reservoir tank disposed below the seat and fluidly connected to the hydraulic transaxle;
a cooling fan disposed in the bonnet and driven by the prime mover; and
a cooling duct extended from an end portion of the bonnet to a space below the seat so as to guide air blown by the cooling fan to the reservoir tank.

15. A lawn tractor comprising:
a bonnet;
a prime mover covered with the bonnet;
a hydraulic pump driven by the prime mover;
a hydraulic transaxle separated from the hydraulic pump and driven by the hydraulic pump;
a mower driven by the prime mover;
a cooling fan disposed in the bonnet and driven by the prime mover;
a seat facing the bonnet and having a space therebelow; and
a cooling duct for guiding air blown by the cooling duct into the space below the seat, wherein a sump of fluid used for the hydraulic transaxle is disposed in the cooling duct so as to be cooled by the cooling fan.
